(19) United States
(12) Patent Application Publication
(10) Pub. No.: US 2017/0161580 A1
(43) Pub. Date: Jun. 8, 2017

(54) METHOD AND SYSTEM FOR TEXT-IMAGE ORIENTATION

(71) Applicant: ABBYY Development LLC, Moscow (RU)

(72) Inventors: Iurii Chulinin, Moscow (RU); Yury Vatlin, Moscow (RU); Dmitry Deryagin, Moscow (RU)

(21) Appl. No.: 14/971,629

(22) Filed: Dec. 16, 2015

(30) Foreign Application Priority Data
Dec. 2, 2015 (RU) 2015151698

(51) Int. Cl. G06K 9/32; G06K 9/72

(52) U.S. Cl. CPC G06K 9/3208; G06K 9/72; G06K 2209/01

(57) ABSTRACT

The current application is directed to a method and system for automatically determining the sense orientation of regions of scanned-document images. In one implementation, the sense-orientation method and system to which the current application is directed employs a relatively small set of orientation characters that occur frequently in printed text. In this implementation, for at least one set of orientation characters, each of two or more different orientations of character-containing subregions within a text-containing region of a scanned-document image are compared to each orientation character in the at least one set of orientation characters in order to determine an orientation for each of the character-containing subregions with respect to a reference orientation of the text-containing region. The determined orientations for the character-containing subregions are then used to determine an overall sense orientation for the text-containing region of the scanned-document image.

### CROSS REFERENCE TO RELATED APPLICATIONS

The present application claims the benefit of priority under 35 USC 119 to Russian Patent Application No. 2015151698, filed Dec. 2, 2015; the disclosure of which is herein incorporated by reference in its entirety.

### TECHNICAL FIELD

The current application is directed to automated processing of scanned-document images and other text-containing images and, in particular, to a method and system for determining a sense orientation for a region or block of an image containing text.

### BACKGROUND

Printed, typewritten, and handwritten documents have long been used for recording and storing information. Despite current trends towards paperless offices, printed documents continue to be widely used in commercial, institutional, and home environments. With the development of modern computer systems, the creation, storage, retrieval, and transmission of electronic documents has evolved, in parallel with continued use of printed documents, into an extremely efficient and cost-effective alternative information-recording and information-storage medium. Because of overwhelming advantages in efficiency and cost effectiveness enjoyed by modern electronic-document-based information storage and information transactions, printed documents are routinely converted into electronic documents by various methods and systems, including conversion of printed documents into digital scanned-document images using electro-optico-mechanical scanning devices, digital cameras, and other devices and systems followed by automated processing of the scanned-document images to produce electronic documents encoded according to one or more of various different electronic-document-encoding standards. As one example, it is now possible to employ a desktop scanner and sophisticated optical-character-recognition (“OCR”) programs running on a personal computer to convert a printed-paper document into a corresponding electronic document that can be displayed and edited using a word-processing program.

While modern OCR programs have advanced to the point that complex printed documents that include pictures, frames, line boundaries, and other non-text elements as well as text symbols of any of many common alphabet-based languages can be automatically converted to electronic documents, challenges remain with respect to conversion of printed documents containing text symbols of non-alphabetic languages into corresponding electronic documents.

### SUMMARY

The current application is directed to a method and system for automatically determining the sense orientation of regions of scanned-document images. In one implementation, the sense-orientation method and system to which the current application is directed employs a relatively small set of orientation characters that occur frequently in printed text. In this implementation, for at least one set of orientation characters, each of two or more different orientations of character-containing subregions within a text-containing region of a scanned-document image are compared to each orientation character in the at least one set of orientation characters in order to determine an orientation for each of the character-containing subregions with respect to a reference orientation of the text-containing region. The determined orientations for the character-containing subregions are then used to determine an overall sense orientation for the text-containing region of the scanned-document image.

### BRIEF DESCRIPTION OF THE DRAWINGS

FIG. 1A illustrates a printed document.

FIG. 1B illustrates a printed document.

FIG. 2 illustrates a typical desktop scanner and personal computer that are together used to convert printed documents into digitally encoded electronic documents stored in mass-storage devices and/or electronic memories.

FIG. 3 illustrates operation of the optical components of the desktop scanner shown in FIG. 2.

FIG. 4 provides a general architectural diagram for various types of computers and other processor-controlled devices.

FIG. 5 illustrates digital representation of a scanned document.

FIG. 6 shows six different regions within a scanned-document image recognized during an initial phase of scanned-document-image conversion, using the example document 100 shown in FIG. 1.

FIG. 7 illustrates a rotation in a horizontal plane.

FIG. 8 illustrates one approach to determining an initial orientation for a text-containing region.

FIG. 9 illustrates one approach to determining an initial orientation for a text-containing region.

FIG. 10 illustrates one approach to determining an initial orientation for a text-containing region.

FIG. 11A illustrates 16 different possible sense orientations for the text-containing region.

FIG. 11B illustrates 16 different possible sense orientations for the text-containing region.

FIG. 11C illustrates 16 different possible sense orientations for the text-containing region.

FIG. 11D illustrates 16 different possible sense orientations for the text-containing region.

FIG. 12 illustrates a challenge with respect to recognition of text characters of various types of character-based languages or languages in which text is not written as simple strings of alphabetic characters.

FIG. 13 illustrates rotational symmetries of characters or symbols.

FIG. 14A illustrates a previously described approach to generating a probable absolute orientation for the text-containing region as well as several alternative text-region-orientation methods to which the current document is directed.

FIG. 14B illustrates a previously described approach to generating a probable absolute orientation for the text-containing region as well as several alternative text-region-orientation methods to which the current document is directed.

FIG. 14C illustrates a previously described approach to generating a probable absolute orientation for the text-containing region as well as several alternative text-region-orientation methods to which the current document is directed.

FIG. 14D illustrates a previously described approach to generating a probable absolute orientation for the text-containing region as well as several alternative text-region-orientation methods to which the current document is directed.

FIG. 14E illustrates a previously described approach to generating a probable absolute orientation for the text-containing region as well as several alternative text-region-orientation methods to which the current document is directed.

FIG. 14F illustrates a previously described approach to generating a probable absolute orientation for the text-containing region as well as several alternative text-region-orientation methods to which the current document is directed.

FIG. 15 illustrates a first step in the determination of the orientation of a character-containing subregion according to the methods to which the current document is directed.

FIG. 16A illustrates the use of framed-character subregions to compute metric-value vectors for a framed character.

FIG. 16B illustrates the use of framed-character subregions to compute metric-value vectors for a framed character.

FIG. 16C illustrates the use of framed-character subregions to compute metric-value vectors for a framed character.

FIG. 16D illustrates the use of framed-character subregions to compute metric-value vectors for a framed character.

FIG. 16E illustrates the use of framed-character subregions to compute metric-value vectors for a framed character.

FIG. 16F illustrates the use of framed-character subregions to compute metric-value vectors for a framed character.

FIG. 16G illustrates the use of framed-character subregions to compute metric-value vectors for a framed character.

FIG. 16H illustrates the use of framed-character subregions to compute metric-value vectors for a framed character.

FIG. 17A illustrates an example metric-value transformation.

FIG. 17B illustrates an example metric-value transformation.

FIG. 18 provides a table that shows a small number of example transformation classes.

FIG. 19A provides control-flow diagrams that illustrate a generalized text-containing-region orientation method that encompasses the methods discussed above with reference to FIGS. 14E and F.

FIG. 19B provides control-flow diagrams that illustrate a generalized text-containing-region orientation method that encompasses the methods discussed above with reference to FIGS. 14E and F.

FIG. 19C provides control-flow diagrams that illustrate a generalized text-containing-region orientation method that encompasses the methods discussed above with reference to FIGS. 14E and F.

FIG. 19D provides control-flow diagrams that illustrate a generalized text-containing-region orientation method that encompasses the methods discussed above with reference to FIGS. 14E and F.

FIG. 19E provides control-flow diagrams that illustrate a generalized text-containing-region orientation method that encompasses the methods discussed above with reference to FIGS. 14E and F.

FIG. 19F provides control-flow diagrams that illustrate a generalized text-containing-region orientation method that encompasses the methods discussed above with reference to FIGS. 14E and F.

FIG. 19G provides a control-flow diagram that illustrate a compute-score method for a comparison of metrics computed for a symbol-containing subregion and metrics computed for each character-orientation/orientation pair.

FIG. 19H provides a control-flow diagram that illustrate a compute-orientation method for a computation of a text-containing-region orientation.

### DETAILED DESCRIPTION

The current application is directed to a method and system for determining the sense orientation of a text-containing region of a scanned-document image by identifying the orientations of a number of orientation characters or symbols within the text-containing region. In the following discussion, scanned-document images and electronic documents are first introduced, followed by a discussion of techniques for general orientation of text-containing scanned-document-image regions. Challenges with respect to orientating image regions containing text characters of a language, particularly a language that is not written as strings of sequential alphabetic symbols, is then discussed. Finally, orientation characters or orientation-character patterns are described and a detailed description of the methods and systems for using orientation-character patterns to determine the sense orientation of a text-containing region of a scanned-document image is provided.

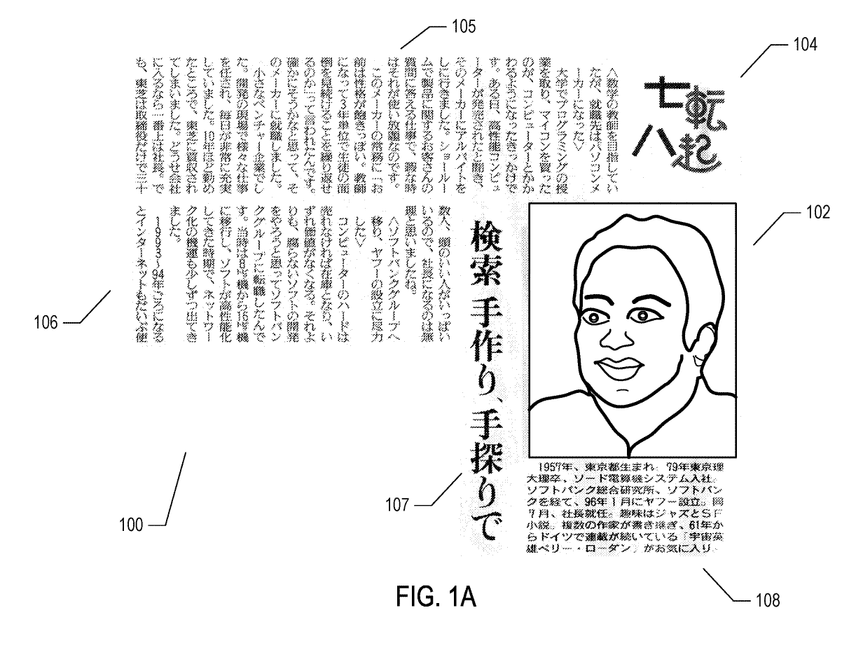

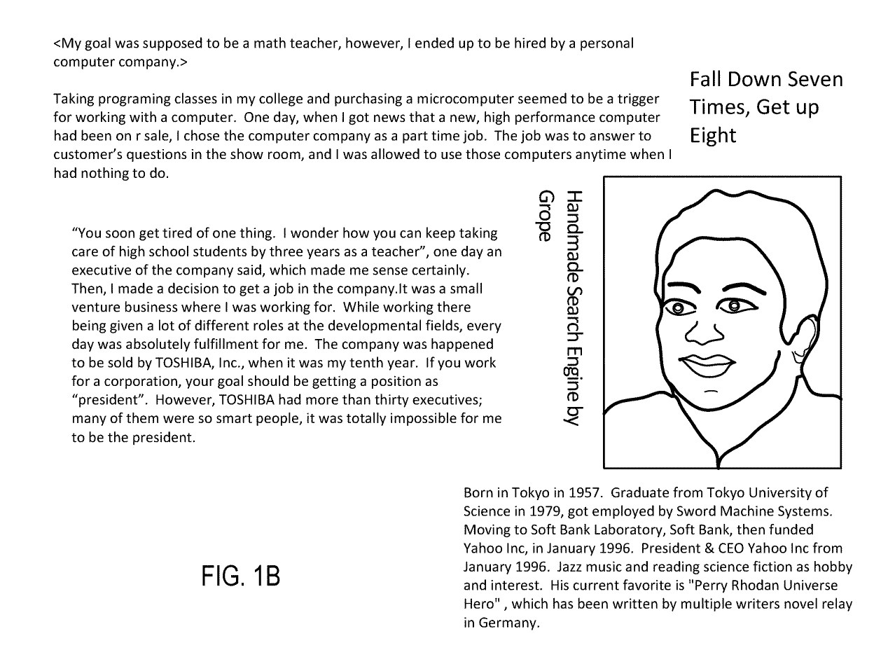

FIGS. 1A-B illustrates a printed document. FIG. 1A shows the original document with Japanese text. The printed document 100 includes a photograph 102 and five different text-containing regions 104-108 that include Japanese characters. This is an example document used in the following discussion of the method and systems for sense-orientation determination to which the current application is directed. The Japanese text may be written in left-to-right fashion, along horizontal rows, as English is written, but may alternatively be written in top-down fashion within vertical columns. For example, region 107 is clearly written vertically while text block 108 includes text written in horizontal rows. FIG. 1B shows the printed document illustrated in FIG. 1A translated into English.

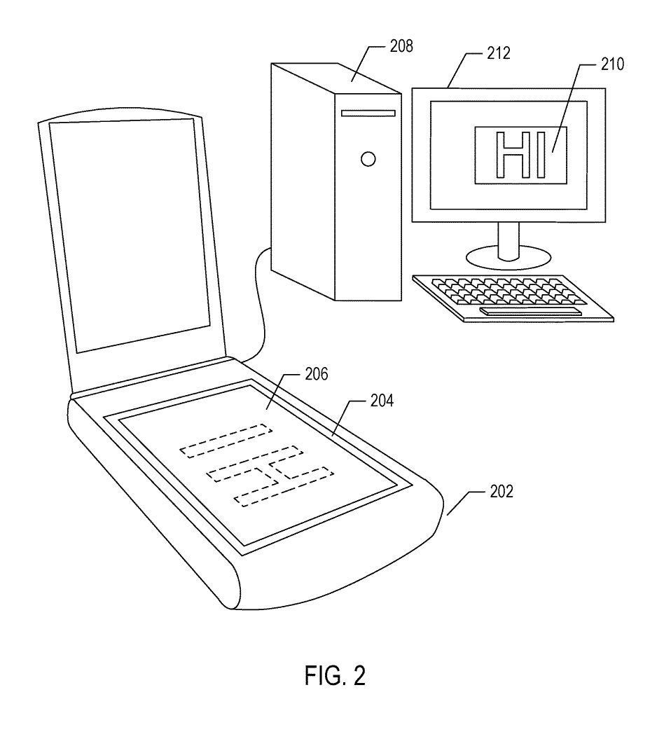

Printed documents can be converted into digitally encoded, scanned-document images by various means, including electro-optico-mechanical scanning devices and digital cameras. FIG. 2 illustrates a typical desktop scanner and personal computer that are together used to convert printed documents into digitally encoded electronic documents stored in mass-storage devices and/or electronic memories. The desktop scanning device 202 includes a transparent glass bed 204 onto which a document is placed, face down 206. Activation of the scanner produces a digitally encoded scanned-document image which may be transmitted to the personal computer (“PC”) 208 for storage in a mass-storage device. A scanned-document-image-rendering program may render the digitally encoded scanned-document image for display 210 on a PC display device 212.

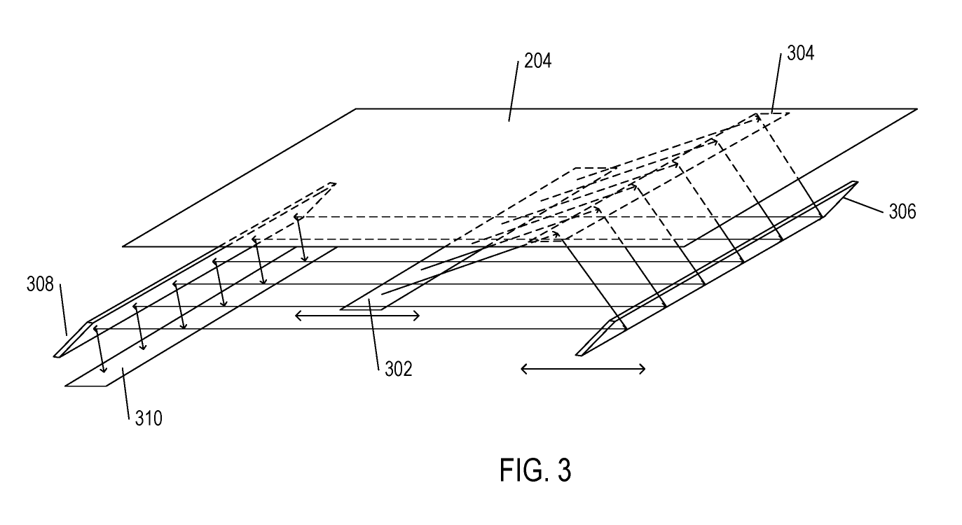

FIG. 3 illustrates operation of the optical components of the desktop scanner shown in FIG. 2. The optical components in this charge-coupled-device (“CCD”) scanner reside below the transparent glass bed 204. A laterally translatable bright-light source 302 illuminates a portion of the document being scanned 304 which, in turn, re-emits and reflects light downward. The re-emitted and reflected light is reflected by a laterally translatable mirror 306 to a stationary mirror 308, which reflects the emitted light onto an array of CCD elements 310 that generate electrical signals proportional to the intensity of the light falling on each of the CCD elements. Color scanners may include three separate rows or arrays of CCD elements with red, green, and blue filters. The laterally translatable bright-light source and laterally translatable mirror move together along a document to produce a scanned-document image. Another type of scanner is referred to as a “contact-image-sensor scanner” (“CIS scanner”). In a CIS scanner, moving colored light-emitting diodes (“LEDs”) provide document illumination, with light reflected from the LEDs sensed by a photodiode array that moves together with the colored light-emitting diodes.

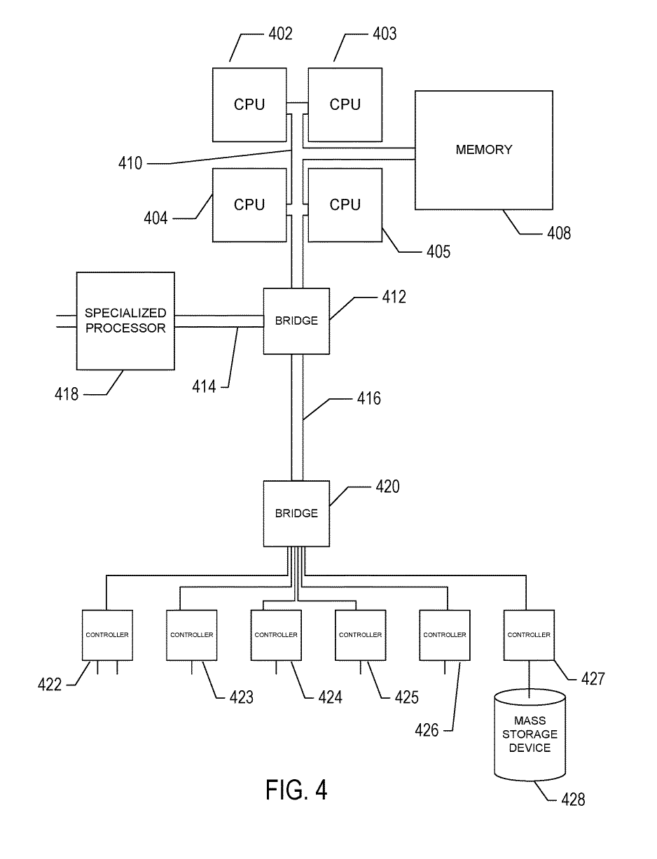

FIG. 4 provides a general architectural diagram for various types of computers and other processor-controlled devices. The high-level architectural diagram may describe a modern computer system, such as the PC in FIG. 2, in which scanned-document-image-rendering programs and optical-character-recognition programs are stored in mass-storage devices for transfer to electronic memory and execution by one or more processors. The computer system contains one or multiple central processing units (“CPUs”) 402-405, one or more electronic memories 408 interconnected with the CPUs by a CPU/memory-subsystem bus 410 or multiple busses, a first bridge 412 that interconnects the CPU/memory-subsystem bus 410 with additional busses 414 and 416, or other types of high-speed interconnection media, including multiple, high-speed serial interconnects. These busses or serial interconnections, in turn, connect the CPUs and memory with specialized processors, such as a graphics processor 418, and with one or more additional bridges 420, which are interconnected with high-speed serial links or with multiple controllers 422-427, such as controller 427, that provide access to various different types of mass-storage devices 428, electronic displays, input devices, and other such components, subcomponents, and computational resources.

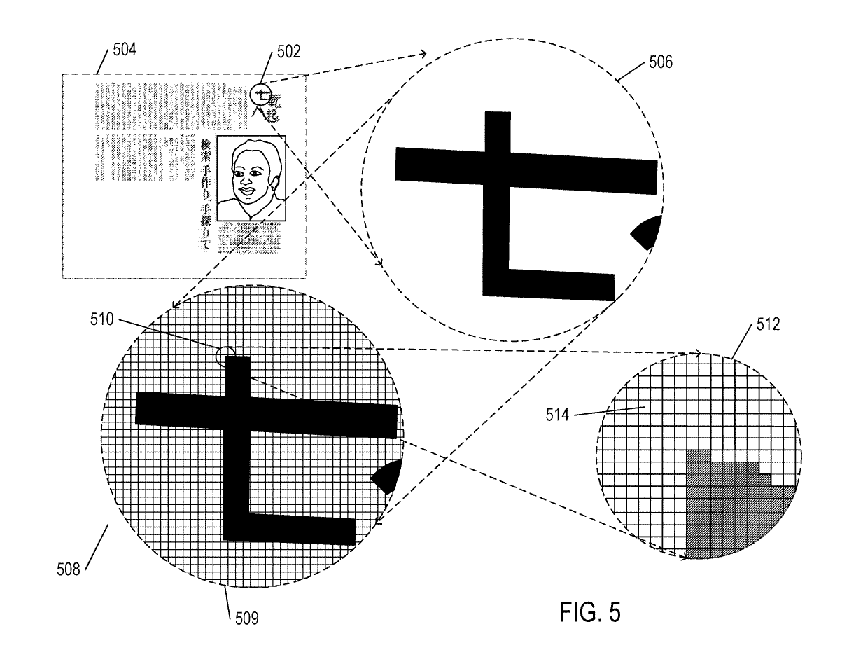

FIG. 5 illustrates digital representation of a scanned document. In FIG. 5, a small disk-shaped portion 502 of the example printed document 504 is shown magnified 506. A corresponding portion of the digitally encoded scanned-document image 508 is also represented in FIG. 5. The digitally encoded scanned document includes data that represents a two-dimensional array of pixel-value encodings. In the representation 508, each cell of a grid below the characters, such as cell 509, represents a square matrix of pixels. A small portion 510 of the grid is shown at even higher magnification, 512 in FIG. 5, at which magnification the individual pixels are represented as matrix elements, such as matrix element 514. At this level of magnification, the edges of the characters appear jagged, since the pixel is the smallest granularity element that can be controlled to emit specified intensities of light. In a digitally encoded scanned-document file, each pixel is represented by a fixed number of bits, with the pixel encodings arranged sequentially. Header information included in the file indicates the type of pixel encoding, dimensions of the scanned image, and other information that allows a digitally encoded scanned-document-image rendering program to extract the pixel encodings and issue commands to a display device or printer to reproduce the pixel encodings in a two-dimensional representation of the original document. Scanned-document images digitally encoded in monochromatic grayscale commonly use 8-bit or 16-bit pixel encodings, while color scanned-document images may use 24 bits or more to encode each pixel according to various different color-encoding standards. As one example, the commonly used RGB standard employs three 8-bit values encoded within a 24-bit value to represent the intensity of red, green, and blue light. Thus, a digitally encoded scanned image generally represents a document in the same fashion that visual scenes are represented in digital photographs. Pixel encodings represent light intensity in particular, tiny regions of the image and, for colored images, additionally represent a color. There is no indication, in a digitally encoded scanned-document image, of the meaning of the pixels encodings, such as indications that a small two-dimensional area of contiguous pixels represents a text character.

By contrast, a typical electronic document produced by a word-processing program contains various types of line-drawing commands, references to image representations, such as digitally encoded photographs, and digitally encoded text characters. One commonly used encoding standard for text characters is the Unicode standard. The Unicode standard commonly uses 8-bit bytes for encoding American Standard Code for Information Exchange (“ASCII”) characters and 16-bit words for encoding symbols and characters of many languages, including Japanese, Mandarin, and other non-alphabetic-character-based languages. A large part of the computational work carried out by an OCR program is to recognize images of text characters in a digitally encoded scanned-document image and convert the images of characters into corresponding Unicode encodings. Clearly, encoding text characters in Unicode takes far less storage space than storing pixilated images of text characters. Furthermore, Unicode-encoded text characters can be edited, reformatted into different fonts, and processed in many additional ways by word-processing programs while digitally encoded scanned-document images can only be modified through specialized image-editing programs.

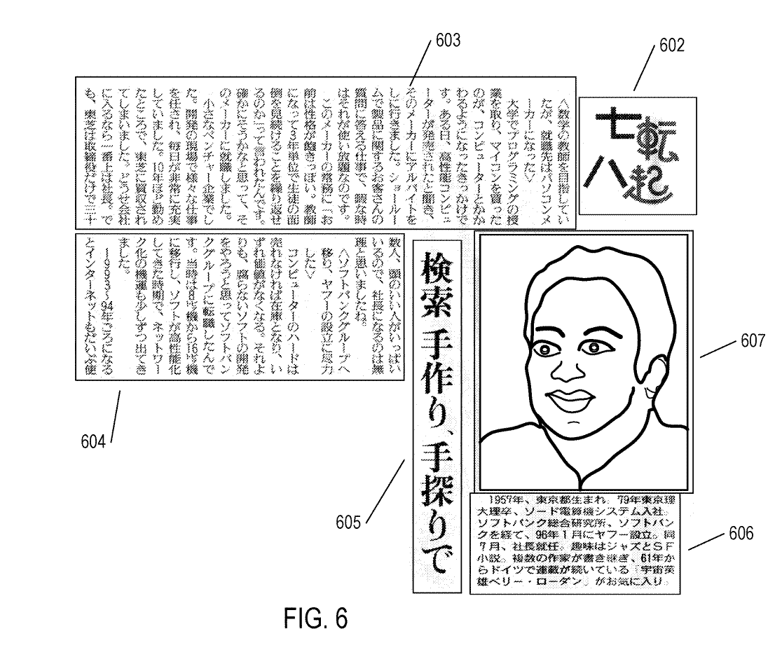

In an initial phase of scanned-document-image-to-electronic-document conversion, a printed document, such as the example document 100 shown in FIG. 1, is analyzed to determine various different regions within the document. In many cases, the regions may be logically ordered as a hierarchical acyclic tree, with the root of the tree representing the document as a whole, intermediate nodes of the tree representing regions containing smaller regions, and leaf nodes representing the smallest identified regions. FIG. 6 shows six different regions within the example document 100 shown in FIG. 1 recognized during an initial phase of scanned-document-image conversion. In this case, the tree representing the document would include a root node corresponding to the document as a whole and six leaf nodes each corresponding to one of the identified regions 602-607. The regions can be identified using a variety of different techniques, including many different types of statistical analyses of the distributions of pixel encodings, or pixel values, over the area of the image. For example, in a color document, a photograph may exhibit a larger variation in color over the area of the photograph as well as higher-frequency variations in pixel-intensity values than regions containing text.

Once an initial phase of analysis has determined the various different regions of a scanned-document image, those regions likely to contain text are further processed by OCR routines in order to identify text characters and convert the text characters into Unicode or some other character-encoding standard. In order for the OCR routines to process text-containing regions, an initial orientation of the text-containing region needs to be determined so that various pattern-matching methods can be efficiently employed by the OCR routines to identify text characters. It should be noted that the images of documents may not be properly aligned within scanned-document images due to positioning of the document on a scanner or other image-generating device, due to non-standard orientations of text-containing regions within a document, and for other reasons. Were the OCR routines unable to assume a standard orientation of lines and columns of text, the computational task of matching character patterns with regions of the scanned-document image would be vastly more difficult and less efficient, since the OCR routines would generally need to attempt to rotate a character pattern at angular intervals over 360° and attempt to match the character pattern to a potential text-symbol-containing image region at each angular interval.

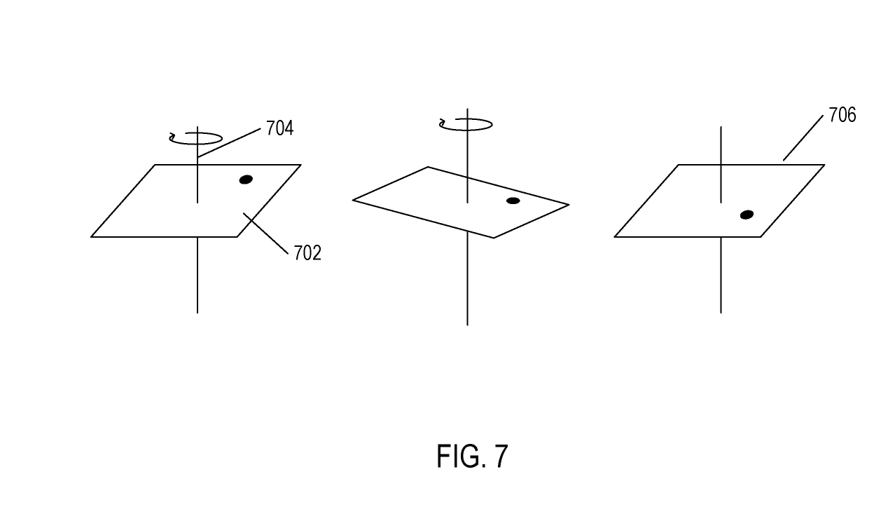

To be clear, the initial orientation is concerned with rotations of the text-containing region in the horizontal plane. FIG. 7 illustrates a rotation in a horizontal plane. In FIG. 7, a square region of a scanned-document image 702 is positioned horizontally with a vertical rotation axis 704 passing through the center of the region. Rotation of the square region in a clockwise direction by 90° produces the orientation 706 shown at the right-hand side of FIG. 7.

Generally, once a text-containing region is identified, the image of the text-containing region is converted from a pixel-based image to a bitmap, in a process referred to as “binarization,” with each pixel represented by either the bit value “0,” indicating that the pixel is not contained within a portion of a text character, or the bit value “1,” indicating that the pixel is contained within a text character. Thus, for example, in a black-and-white-text-containing scanned-document-image region, where the text is printed in black on a white background, pixels with values less than a threshold value, corresponding to dark regions of the image, are translated into bits with value “1” while pixels with values equal to or greater than the threshold value, corresponding to background, are translated into bits with value “0.” The bit-value convention is, of course, arbitrary, and an opposite convention can be employed, with the value “1” indicating background and the value “0” indicating character. The bitmap may be compressed, using run-length encoding (“RLE”), for more efficient storage.

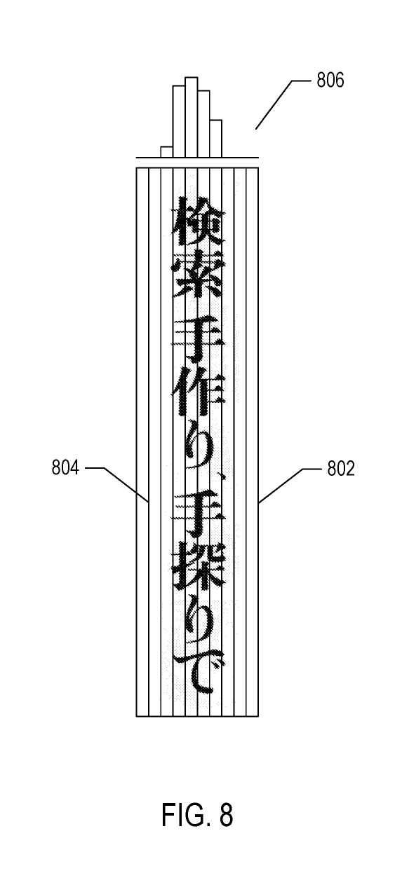

FIGS. 8-10 illustrate one approach to determining an initial orientation for a text-containing region. FIG. 8 shows the generation of a histogram corresponding to one orientation of a text-containing region. In FIG. 8, a text-containing region 802 is vertically oriented. The text-containing region is partitioned into columns demarcated by vertical lines, such as vertical line 804. The number of 1-valued bits in the bitmap corresponding to the text-containing region is counted, in each column, and used to generate a histogram 806 shown above the text-containing region. Columns in the text-containing region containing no portions of characters or, equivalently, only “0”-valued bits, have no corresponding columns in the histogram while columns containing portions of characters are associated with columns in the histogram with heights corresponding to the proportion of bits within the column having value “1.” The histogram column heights may alternatively be scaled to reflect the absolute number of 1-valued bits or may alternatively represent a fraction of bits in the column with value “1” or the fraction of the number of 1-valued bits in a column with respect to the total number of 1-valued bits in the text-containing region.

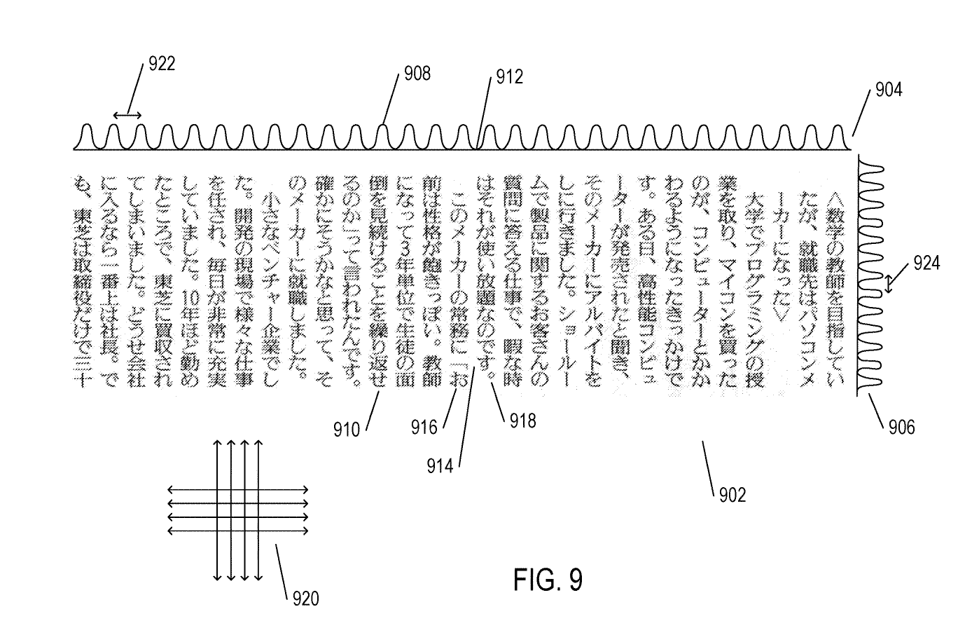

FIG. 9 shows histograms generated for columns and rows of a properly oriented text-containing region. In FIG. 9, a text-containing region 902 is aligned with the page boundaries, with rows of text parallel to the top and bottom of the page and columns of text parallel to the sides of the page. The histogram-generation method discussed above with reference to FIG. 8 has been applied to the entire text-containing region 902 to generate histograms for vertical columns within the text-containing region 904 and for horizontal rows within the text-containing region 906. Note that the histograms are shown as continuous curves with the peaks of the curves, such as peak 908 in histogram 904, corresponding to the central portions of text columns and rows, such as text column 910 to which peak 908 corresponds, and valleys, such as valley 912, corresponding to the white-space columns and rows between text columns and text rows, such as the white-space column 914 between text columns 916 and 918. The grid of arrows 920 in FIG. 9 indicates the direction of the vertical and horizontal partitionings used to generate the column histogram 904 and the row histogram 906.

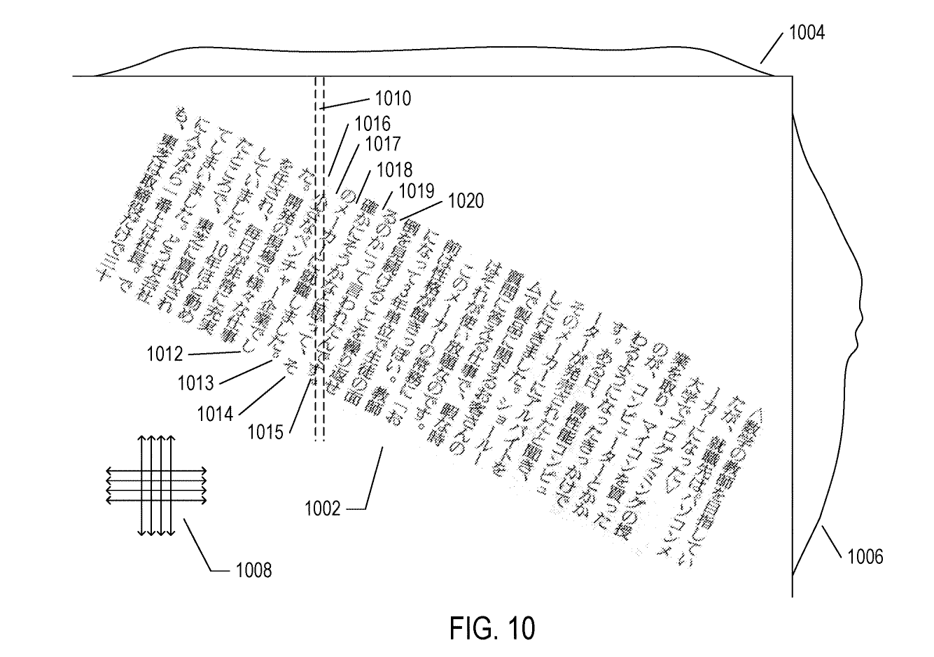

FIG. 10 shows the same text-containing image region shown in FIG. 9 but having a different rotational orientation. The same technique described above with reference to FIG. 9 is applied to the differently oriented text-containing region 1002 to generate the column histogram 1004 and row histogram 1006 using column and row partitions in the direction of the vertical and horizontal arrows 1008. In this case, the histograms are generally featureless, and do not show the regularly spaced peaks and valleys as in the histograms shown in FIG. 9. The reason for this is easily seen by considering the vertical column 1010 shown in FIG. 10 with dashed lines. This vertical column passes through text columns 1012-1015 and white-space columns 1016-1020. Almost every vertical column and horizontal row, other than those at the extreme ends of the histograms, passes through both text and white space, as a result of which each of the vertical columns and horizontal rows generally includes 1-valued bits and 0-valued bits.

Thus, the optical-character-recognition (“OCR”) routines can initially orient a text-containing region by rotating the text-containing region through 90° and computing column and row histogram at angular intervals and by then selecting an initial orientation which produces at least one comb-like histogram and generally two comb-like histograms, as shown in FIG. 9, with best peak-to-trough ratios. Note also that the spacing between characters in rows and columns may be inferred from the spacings 922 and 924 between peaks in the column and row histograms.

There are many different alternative possible methods for determining an initial orientation of a text-containing region. The method discussed above with reference to FIGS. 8-10 is provided as an example of the types of approaches that may be employed. In many cases, the spacings between characters may not be as regular as those shown in the example used in FIGS. 9-10, as a result of which different techniques may be used to determine character boundaries. In one such approach, vertical white-space columns are identified within a horizontal row of text characters and the distances between such columns are tabulated in a histogram. Character boundaries are then determined as a traversal path through the row from one white-space column to another with path elements most closely corresponding to expected inter-white-space-column distance intervals based on the histogram.

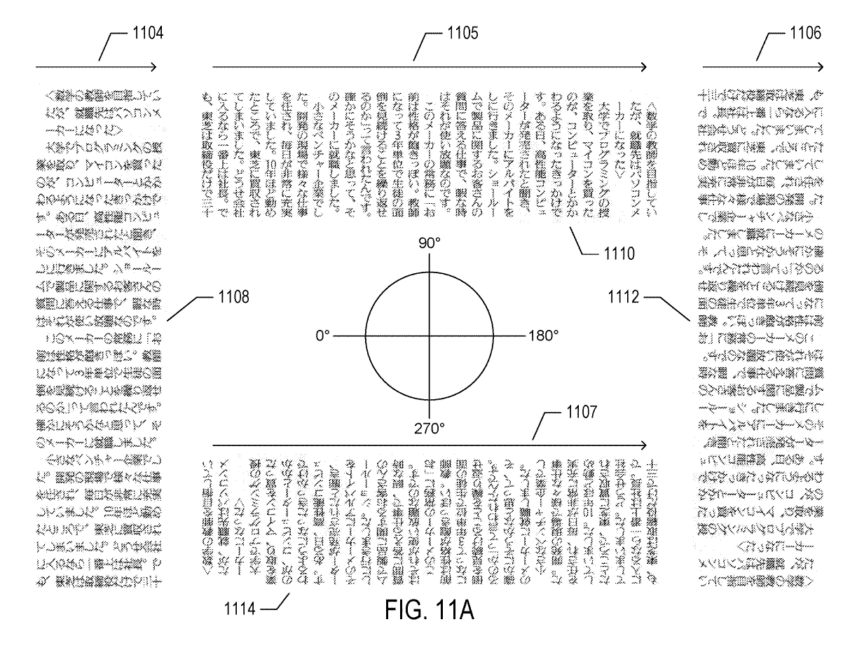

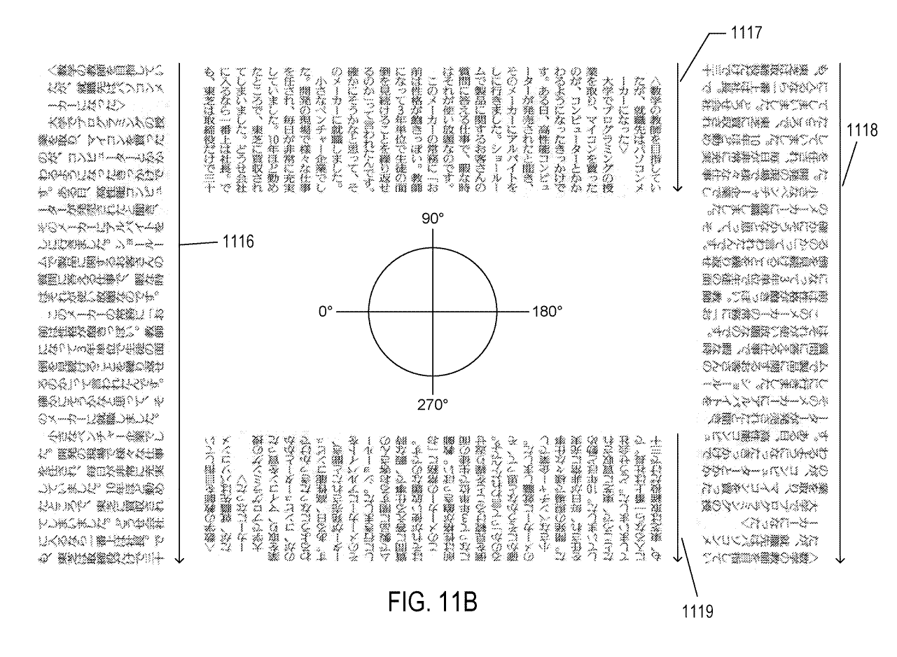

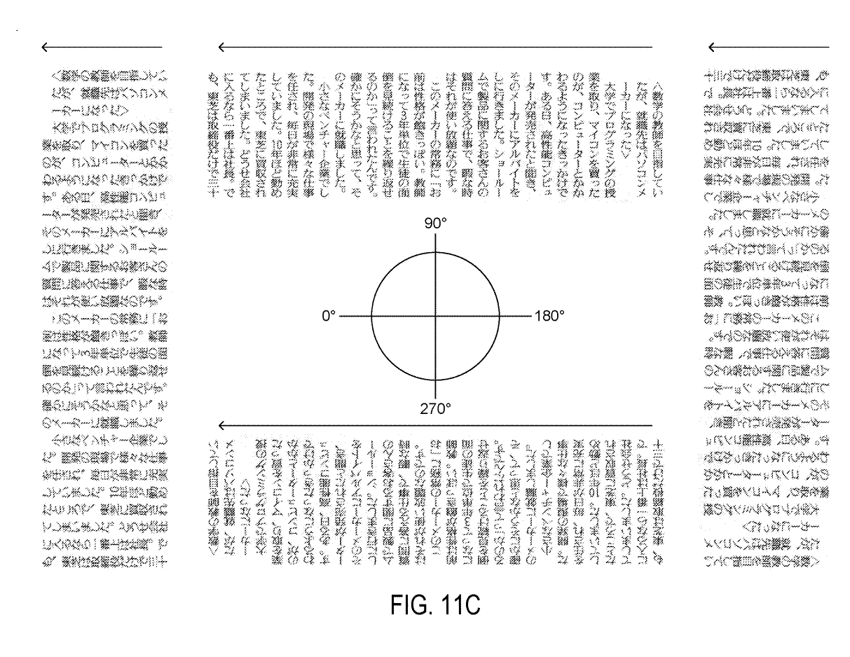

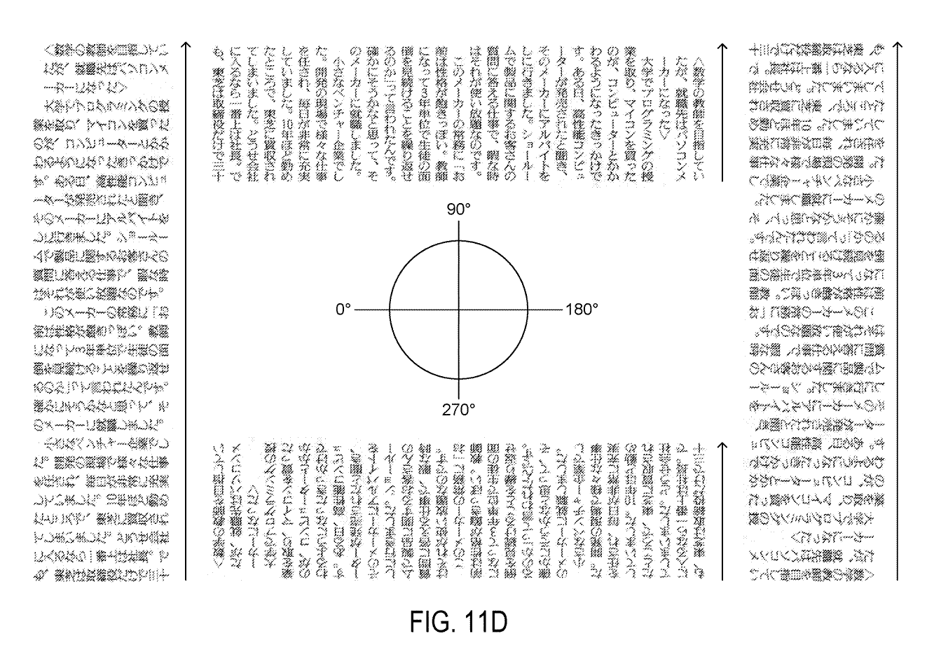

Once an initial orientation has been established, there are still at least 16 different possible sense orientations for the text-containing region. FIGS. 11A-D illustrate 16 different possible sense orientations. FIG. 11A shows four of the 16 different possible sense orientations of the example text-containing region used in FIGS. 9 and 10. In these sense orientations, the text characters are assumed to be read left to right in horizontal rows, as indicated by arrows 1104-1107. Assuming an initial orientation of the text-containing region shown in the left-hand side of FIG. 11A 1108, which is arbitrarily assigned the rotational value of 0°, the text-containing region may be rotated by 90° to produce a second sense orientation 1110, by 180° to produce a third sense orientation 1112, and by 270° to produce a fourth sense orientation 1114.

FIG. 11B shows four more possible sense orientations. In this case, the text is assumed to be read vertically downwards, as indicated by arrows 1116-1119. As with FIG. 11A, the text-containing region may be rotated by 0°, 90°, 180°, and 270° to produce the four additional sense orientations. FIGS. 11C-D show eight additional sense orientations, with the sense orientations shown in FIG. 11C assuming the text to be read from right to left horizontally and the sense orientations shown in FIG. 11D assuming the text to be read vertically from top to bottom.

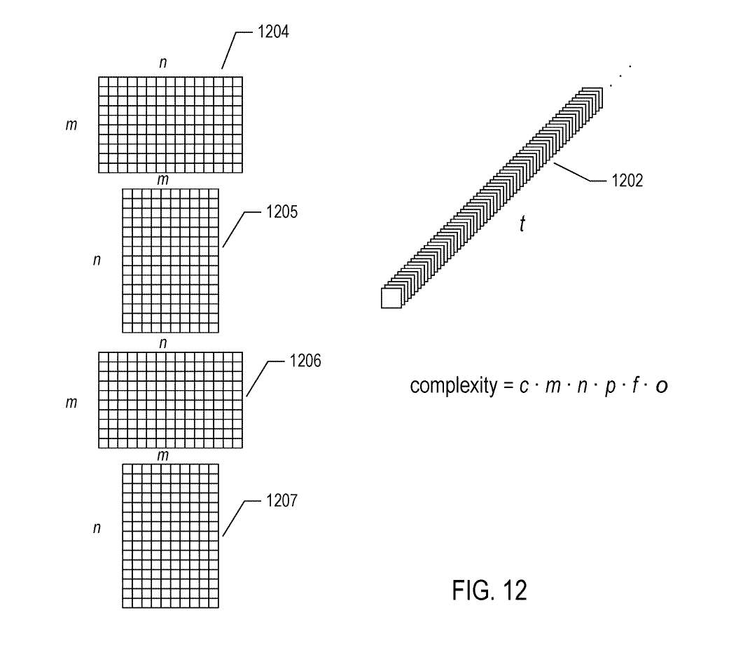

FIG. 12 illustrates a challenge with respect to recognition of text characters of various types of character-based languages or languages in which text is not written as simple strings of alphabetic characters. When the text comprises characters of character-based languages, an OCR routine may need to attempt to match each of 40,000 or more character patterns 1202 to each character image in each possible orientation of a text-containing region. Even when, by various considerations and initial analyses, the number of possible sense orientations can be decreased from the 16 possible sense orientations shown in FIGS. 11A-D to just four possible sense orientations 1204-1207, the computational complexity of the task of determining the actual sense orientation is high. The computational complexity can be expressed as:

computational complexity=c·m·n·p·f·o

where c is the computational complexity involved in matching a single character pattern with the image of a character;
m is the number of rows in the initial 0° orientation;
n is the number of columns in the initial 0° orientation;
p is the number of character patterns for the language;
f is the fraction of character images in the text-containing region that needs to be evaluated in order to successively determine the sense orientation of the text-containing region; and
o is the number of possible sense orientations.
   The computational complexity is dominated by the termp which, as mentioned above, can be as large as 40,000 or more for character-based languages. In one approach, the OCR routine may attempt pattern matching on each possible sense orientation for some fraction f of character images and then determine which of the possible orientations produces the greatest fraction of high-probability pattern matches. Because of the large number of character patterns and the difficulty of the pattern-matching task, it is likely that a substantial fraction f of the character images in the text-containing region may need to be pattern-matched in order to reliably determine the sense orientation of the text-containing region.

The current application is directed to methods and systems for determining the sense orientation of text-containing regions in a scanned-document image that features significantly less computational complexity than the method discussed above with reference to FIG. 12. The methods and systems to which the current application is directed lower the computational complexity of text-containing-region orientation by decreasing both the magnitude of p and c.

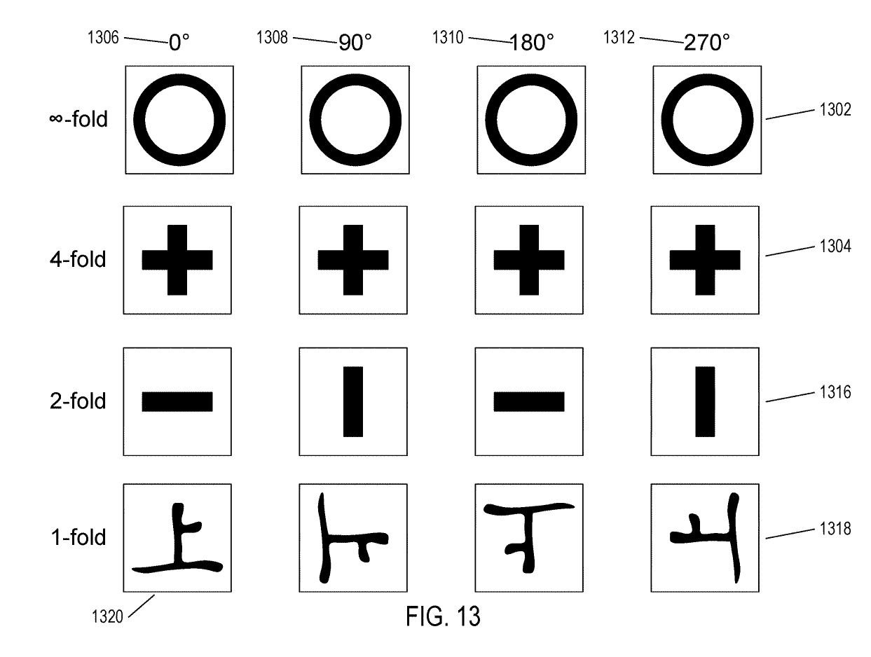

FIG. 13 illustrates rotational symmetries of characters or symbols. In the following discussion, the rotational symmetries of characters are considered. There are an infinite number of different possible rotational symmetries. An example of a text character with the highest rotational symmetry is the alphabet character “o.” As shown in the top row 1302 of FIG. 13, the letter “o” has the same appearance regardless of by what number of degrees the character is rotated about a central rotational axis perpendicular to the plane of the character. This type of rotational axis is referred to as an Go-fold rotational axis. The symbol “+” has four-fold rotational symmetry, as shown in row 1304 in FIG. 13. The appearance of this symbol is illustrated for rotations about a perpendicular, central rotational axis of 0° (1306 in FIG. 13), 90° (1308 in FIG. 13), 180° (1310 in FIGS. 13), and 270° (1312 in FIG. 13). Rotations by a number of degrees other than 0°, 90°, 180°, and 270° would leave the symbol in a rotational orientation that would render the symbol's appearance different than that of the familiar symbol “+,” with a vertical member crossing a horizontal member. The symbol “−” has two-fold rotational symmetry, as illustrated in row 1316 of FIG. 13. This symbol can be rotated by 180° about a central, perpendicular rotational axis without changing the symbol's appearance. In the final row 1318 of FIG. 13, a Japanese symbol with a one-fold rotational axis is shown. For this symbol, there is no orientation, other than the orientation at 0° 1320, at which the symbol has an appearance identical to its appearance at 0° orientation. The one-fold rotational symmetry is the lowest rotational symmetry that a symbol can possess. Symbols with one-fold rotational symmetries are referred to as “asymmetric symbols,” or “asymmetric characters.” Asymmetric characters are desirable candidates for orientation characters that can be used to efficiently determine the sense orientation of a text-containing region according to the methods and systems disclosed in the current application. Please note that the term “character” may refer to a letter within an alphabet or a character or symbol in languages, such as Mandarin. that are based on a large set of picture-like characters rather than elements of an alphabet. In other words, the term “character” refers to an element of a written or printed language, whether or not alphabetic.

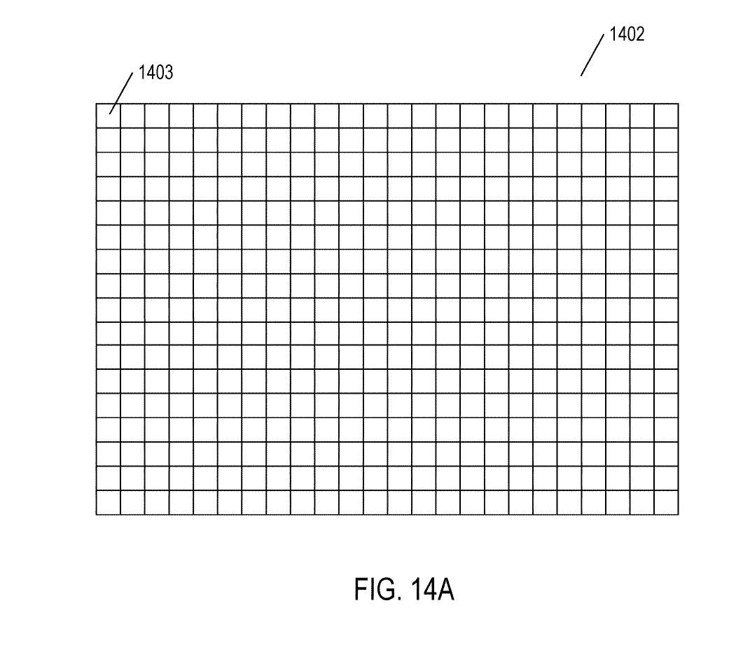

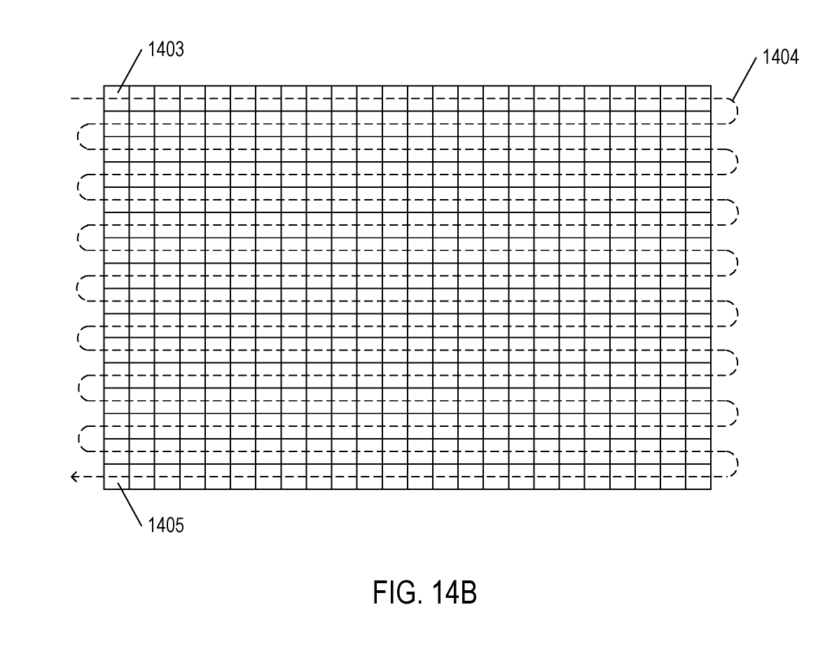

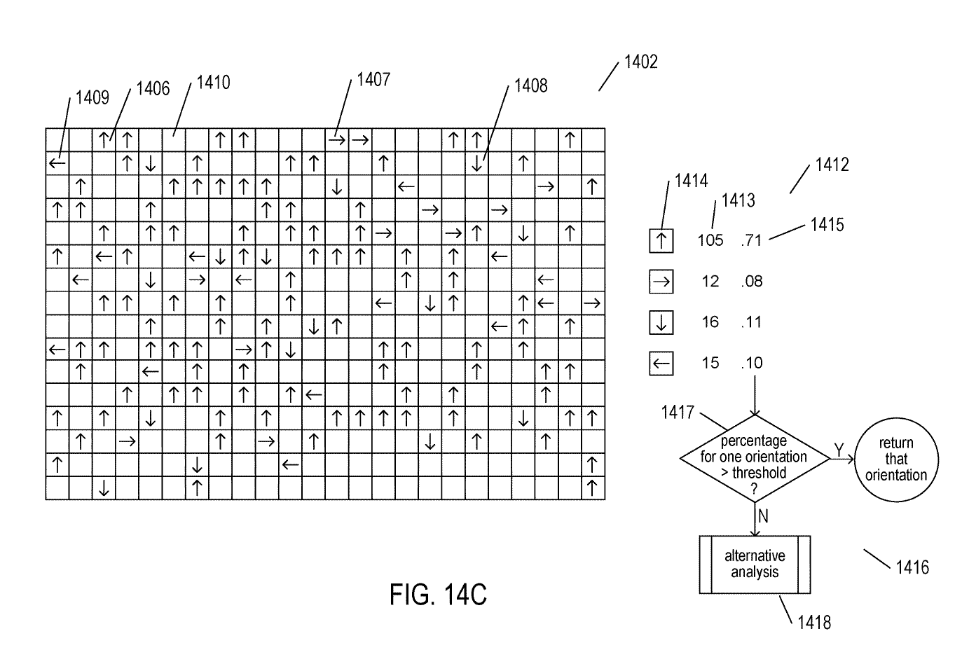

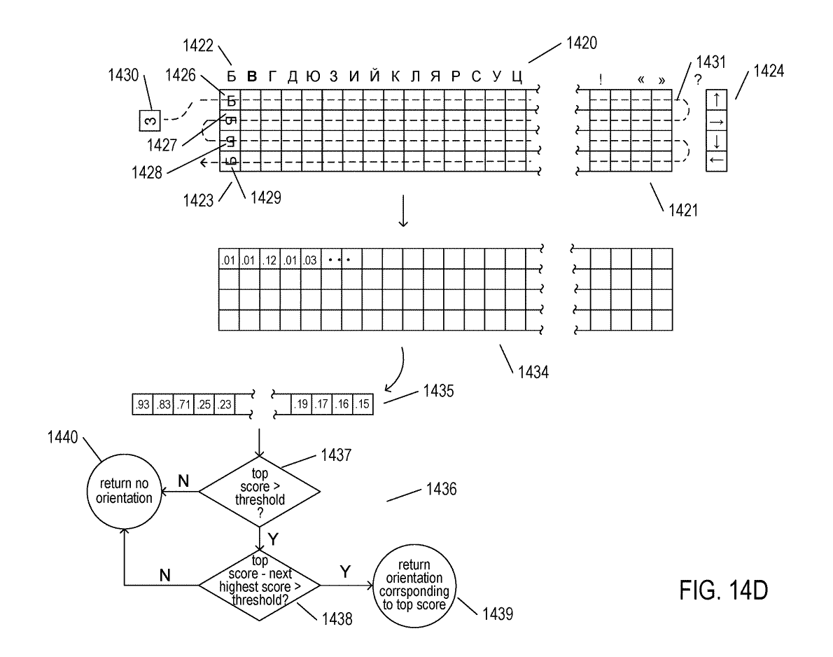

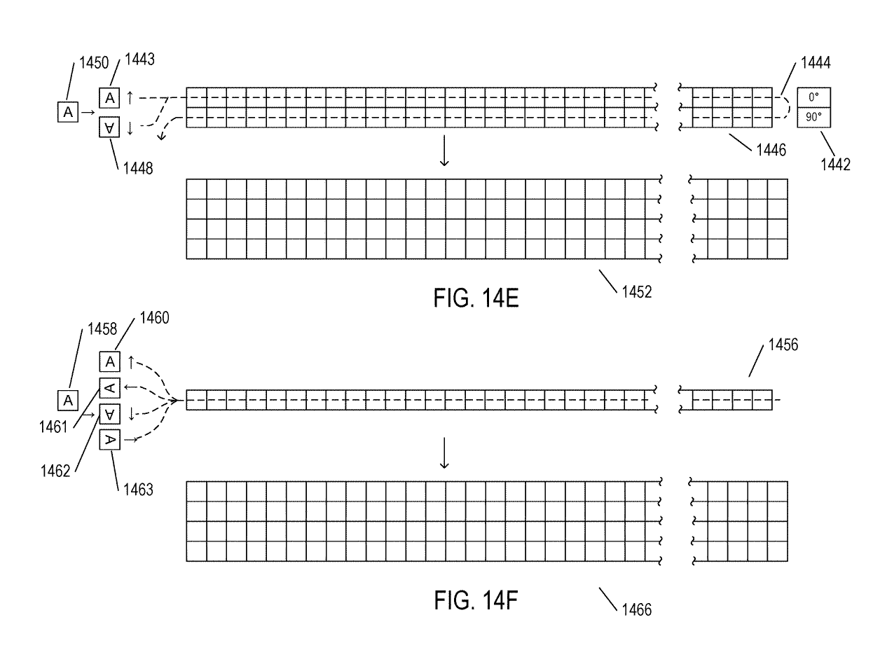

FIGS. 14A-F illustrate a previously described approach to generating a probable absolute orientation for the text-containing region as well as several alternative text-region-orientation methods to which the current document is directed. FIG. 14A illustrates a text-containing region using illustration conventions employed in many of the subsequent figures in this document. The text-containing region 1402 is assumed to have been processed, by any of various methods discussed above, to initially orient the text-containing region and to superimpose a grid over the text-containing region that delimits each character-or-symbol-containing subregion, or character-or-symbol-containing subimage, in the text-containing region. Thus, each cell in the grid-like representation of the text-containing region, such as cell 1403, represents a subregion that contains a single character or symbol. For ease of illustration, it is assumed that a regular rectilinear grid can be superimposed over the text-containing region to delimit the individual character-containing subregions. An irregular grid may need to be used for cases in which the character-containing subregions are not uniformly sized and spaced.

In one approach to generating a probable absolute orientation for the text-containing region, shown in FIG. 14B, each character-containing subregion in the text-containing region is considered, along a traversal path. In FIG. 14B, the traversal path is represented by a dashed serpentine arrow 1404, with each character-containing subregion, beginning with the first character-containing subregion 1403 and ending with the final character-containing subregion 1405 along the traversal path 1404, considered in turn. There are, of course, many different possible traversal paths that can be used. Consideration of a character-containing subregion during the traversal involves computing values for a set of metrics from the pattern of 0 and 1 pixel values within the character-containing subregion and comparing the computed metric values to corresponding computed metric values for a set of orientation characters or symbols. There are many different possible metrics for which values may be computed. For example, one metric is the ratio of 1-valued pixels to the total number of pixels in the character-containing subregion. A value generated by subtracting this value from 1 corresponds to the ratio of 0-valued pixels to the total number of pixels in the character-containing subregion this ratio, a different, related metric. Another metric is the center of mass for the pixel pattern based on the weights 0 and 1 for the pixels within the character-containing subregion. Yet another metric is the size, in pixels, of the largest continuous region of 1-valued pixels. Still another metric is the longest row or column of 1-valued pixels within the character-containing subregion. There are many different possible metrics for which values may be computed for a given character-containing subregion.

As shown in FIG. 14C, the result of the consideration of a character-containing subregion in the traversal discussed above with reference to FIG. 14B is a determination of the probable orientation of the character. As discussed above, initial orientation of the text-containing region results in a 4-fold ambiguity in the orientation of a character with respect to the grid generated by the initial orientation of the text-containing region. The character may be have: (1) a vertical orientation, arbitrarily assigned to the 0° orientation state that is represented by an upward-pointing arrow, such as upward-pointing arrow 1406; (2) a right-directed horizontal orientation, assigned to the 90° orientation state, as represented by arrow 1407; (3) a downward-pointing orientation, assigned to the 180° orientation state, as represented by arrow 1408; or (4) a horizontal, left-pointing orientation, assigned to the 270° orientation state, as represented by arrow 1409. Note that, in the current discussion, a clockwise rotation convention is used. In the example of FIGS. 14A-C, the traversal of the character-containing subregions in the text-containing region results in the determined character orientations shown by arrows in the text-containing region 1402 shown in FIG. 14C. For those characters without an arrow, such as the character within character-containing subregion 1410, a probable orientation could not be determined. Then, as shown in the right-hand side 1412 of FIG. 14C, the number of determined orientations, for each of the four possible orientations described above, are computed along with the percentage of the total determined orientations represented by the particular possible orientation. For example, 105 (1413 in FIG. 14C) vertical orientations (1414 in FIG. 14C) were determined for characters in the text-containing region 1402, which represents 71% (1415 in FIG. 14C) of the number of character-containing subregions for which orientations were determined. As represented by a small control-flow-diagram extract 1416, when the percentage of the total determined orientations for one of the four possible orientations is greater than a threshold value, as determined in step 1417, then that direction is returned as the direction or orientation of the text-containing region. Otherwise, a more elaborate, alternative analysis may be undertaken, as represented by step 1418, to generate a probable absolute orientation for the text-containing region.

FIG. 14D illustrates the determination of the orientation of a particular character-containing subregion in greater detail. A set of orientation characters and/or symbols 1420 is employed in the orientation determination. Each column in the two-dimensional matrix 1421 representing the set of orientation characters corresponds to a single character or symbol of the language in which the document is printed, when the language has been determined, or of two or more possible languages, when the language has not been determined. Thus, each column is indexed by a symbol identity, such as the symbol index 1422 for column 1423. Each row in the two-dimensional matrix 1421 corresponds to one of the four possible orientations for the character. Thus the rows are indexed by the four orientation indices 1424. For example, the symbol “B” 1422 in column 1423 has the four different orientations within the column 1426-1429 corresponding to the orientation indices 1424. A metric value is computed for each metric in a set of metrics and stored for each orientation of each symbol or, in other words, for each cell in the two-dimensional matrix 1421. When a particular character-containing subregion 1430 within the text-region is considered, in the traversal path shown in FIG. 14B, metric values for the character in the orientation state in which it occurs in the initially oriented text-containing region are computed and the computed metric values are then compared to those for each symbol/orientation in a traversal of the two-dimensional matrix 1421, represented by serpentine-dashed arrow 1431 in FIG. 14D. The comparison of the metrics computed for the symbol-containing subregion 1430 and the metrics computed for each symbol/orientation generates a score. In the example shown in FIG. 14D, the larger the score, the more closely the metrics computed for the character-containing subregion 1430 match the metrics for a particular character/orientation. In other comparison methods, including one discussed below, a lower score indicates a better match. Thus, the traversal represented by dashed serpentine arrow 1431 generates a score for each cell in the two-dimensional matrix 1421, as indicated by lower two-dimensional matrix 1434 in FIG. 14D. In other words, the scores that are generated and stored in matrix 1434 represent comparisons of a currently-considered character-containing subregion and each possible orientation of each member of the set of orientation characters and/or symbols 1420. Matrix 1434 thus represents a set of scores, using which a particular orientation for the currently considered character-containing subregion is attempted to be determined. Each cell in the matrix contains a score generated by comparing a set of metrics for a currently considered character-containing subregion and a set of metrics computed for a particular orientation-character/orientation pair, where the column in which the cell resides is associated with a particular orientation character and the row in which the cell resides is associated with a particular orientation. The scores are then sorted, in descending order for the currently described scoring scheme, as represented by array 1435 in FIG. 14D. Finally, a decision is made, as represented by the control-flow-diagram extract 1436 in FIG. 14D. When the top or highest score is greater than a first threshold value, as determined in step 1437, and when the difference between the top score and the next-highest score is greater than a second threshold value, as determined in step 1438, the orientation of the orientation character used to generate the top score is returned, in step 1439. Otherwise, an indication that no orientation could be determined is returned, in step 1440.

The method discussed above with reference to FIGS. 14A-D represents a previously described method for orientating text-containing regions of a document. The effectiveness of the method depends on the number and identities of the orientation characters as well as the particular set of metrics employed for use in comparing a text-containing subregion to a particular orientation character. In general, with a properly determined set of metrics and orientation characters and/or symbols, the method produces reliable text-containing-region orientation. However, particularly for languages with large numbers of characters, such as Mandarin, a very large number of computed metric values, including a set of metric values for each of the four different orientations of each orientation character, need to be stored in memory in order to facilitate the character-containing-subregion traversal represented by dashed serpentine arrow 1431 in FIG. 14D. The memory requirement may become onerous in particular types of processor-controlled devices with limited amounts of memory and/or slow access to memory, including certain mobile devices.

FIGS. 14E-F illustrate two of the methods to which the current application is directed. These methods address the memory-overhead problem attendant with the previously described method discussed above with reference to FIGS. 14A-D. In the new methods, a set of metric values is computed for a currently considered character-containing subregion. Then, during multiple traversals of the orientation characters to compare the metric values computed for the currently considered character-containing subregion with those metric values stored for the orientation characters in an array of stored orientation-character metric values, the computed metric values for the character-containing subregion are transformed, between successive traversals, to generate corresponding metric values for different rotational states of the currently considered character-containing subregion The traversals are carried out over a smaller set of metric-value-containing orientation-character cells in the matrix of stored orientation-character metric values. By transforming the computed metric values of the character-containing subregion to effect a comparison of the possible rotational states of the currently considered character-containing subregion to a subset of the possible orientations of the orientation-characters, rather than storing metric values for each possible orientation of the orientation characters, a significantly smaller amount of memory is used for carrying out the text-containing-region-orientation method.

FIG. 14E shows the first of the two methods that represent the approach to text-containing-region orientation to which the current document is directed. In this method, only two sets of metric values are stored for each orientation character, as represented by the orientation indices 1442. The computed metric values for the original orientation of the character-containing subregion are employed 1443 in a first traversal, represented by dashed serpentine arrow 1444, of the orientation character cells in the smaller two-dimensional matrix 1446. Then, the metric values for the character-containing subregion are transformed to correspond to the metric values that would be computed for the character-containing subregion following a rotation of the character-containing subregion by 180° 1448 and the transformed metric values are employed in a second traversal of the smaller, two-dimensional matrix 1446, as represented by dashed serpentine arrow 1444. The two-dimensional matrix 1446 is half the size of the two-dimensional matrix 1421 shown in FIG. 14D, but two traversals, rather than one, are made over this matrix. Note that each cell in the two-dimensional matrix 1446 belongs to a particular column and a particular row. The column is associated with a particular orientation character and the row is associated with a particular orientation of the orientation character. The metric values stored within a given cell in the two-dimensional matrix can therefore be thought of as representing, or characterizing, a particular orientation-character/orientation pair. Of course, it is also possible to compute two sets of metric values for the character-containing subregion and make two metric-value-set comparisons of the character-containing subregion with metric values for each orientation character in a single traversal. The two approaches are equivalent. By the first method, the same number of scores are computed for the character-containing subregion 1450, as represented by two-dimensional matrix 1452, as are computed by the method discussed above with reference to FIG. 14D. Moreover, a score is computed for each possible relative orientation of the character-containing subregion with respect to each orientation character. In the first traversal, the relative orientations of the character-containing subregion and each orientation character that are evaluated include relative orientations 0° and 90°. In the second traversal, the relative orientations evaluated include 180° and 270°. Since the same number of scores are computed for each character-containing subregion, as represented by two-dimensional matrix 1452 in FIG. 14E, steps similar or identical to those shown in the lower portion of FIG. 14D are carried out to determine an orientation for the character-containing subregion. The method discussed above with reference to FIG. 14E thus uses half as many stored metric values for each orientation character as does the method discussed above with reference to FIG. 14D.

FIG. 14F shows a second new method. In this method, only a single set of metric values are stored for each orientation character in array 1456. The metric values for character-containing subregion 1458 are initially computed and then are transformed three times to provide for comparison of the four different possible orientations 1460-1463 of the currently considered character-containing subregion with respect to each orientation character. The array 1456 is traversed four times, once for each relative orientation of the character-containing subregion with respect to the orientation characters, to produce the same number of scores 1466 as produced by the methods discussed with respect to FIGS. 14E and 14D. Again, a score is produced for each possible relative orientation of the character-containing subregion with respect to each orientation character. The method illustrated in FIG. 14F uses one-fourth of the memory for storing metric values for orientation characters as used by the method discussed above with reference to FIG. 14D. Again, it is equivalent to initially computing the metric values for all four rotational states of the character-containing subregion and then carrying out four comparisons with respect to each orientation character in a single traversal of the metric values stored for the orientation characters. Here again, each cell in array 1456 can be considered to contain metric values for a particular orientation-character/orientation, even though, in this case, there is only one orientation-character/orientation pair for each orientation character.

Returning to FIGS. 14B and 14C, in certain implementations of the text-containing-region orientation methods disclosed in the current document, the traversal of the character-containing subregions, shown in FIG. 14B, may consider only the best candidate character-containing subregions along the traversal path, rather than all of the character-containing subregions. The best candidate character-containing subregions are those that contain assymetrical 1-valued pixel regions, or assymetrical characters, which therefore produce four quite different and easily distinguishable images in the four different rotational states corresponding to rotations of 0°, 90°, 180°, and 270°. As one example, a character-containing subsregion in which all or a great majority of 1-valued pixels occur in one of the four quadrants obtained by vertically and horizontally dividing the character-containing subsregion would be a good candidate for orientation determination, since the appearance of the character-containing subsregion is markedly different for each of the four different rotational states. By choosing only the best candidate character-containing subregions, the computational overhead attendant with attempting to determine the orientation of character-containing subregions that, in the end, cannot be determined, shown as blank cells in matrix 1402 in FIG. 14C, can be avoided.

To summarize, the relatively large memory overhead of the method discussed above with reference to FIGS. 14A-D can be significantly reduced by computing metric values for a character-containing subregion, comparing the initially computed metric values to those stored for the orientation characters, by traversing a small set of stored metric values for the orientation characters, and by then transforming the initially computed metric values for the character-containing subregion prior to each additional traversal of the small set of stored metric values for the orientation characters, rather than storing metric values for each possible rotation of each orientation character, as in the method discussed with reference to FIGS. 14A-D. The new methods, discussed above with reference to FIGS. 14E-F, produce scores for each of the possible relative orientations of the character-containing subregion and each orientation character, just as in the original method discussed above with reference to FIGS. 14A-D, but do so using one-half and one-fourth of the memory devoted to storing orientation-character metrics, respectively, used by the original method.

Were the new methods to carry out a de novo computation of the metric values for each rotational state of the character-containing subregion, the increased computational overhead of these methods might rise above an acceptable level. Therefore, the new methods depend not only on using transformations of the metric values computed for the character-containing subregions during the comparison of the character-containing subregions with orientation characters, but also on efficient methods for transforming the metric values to reflect different rotational states of the character-containing subregion.

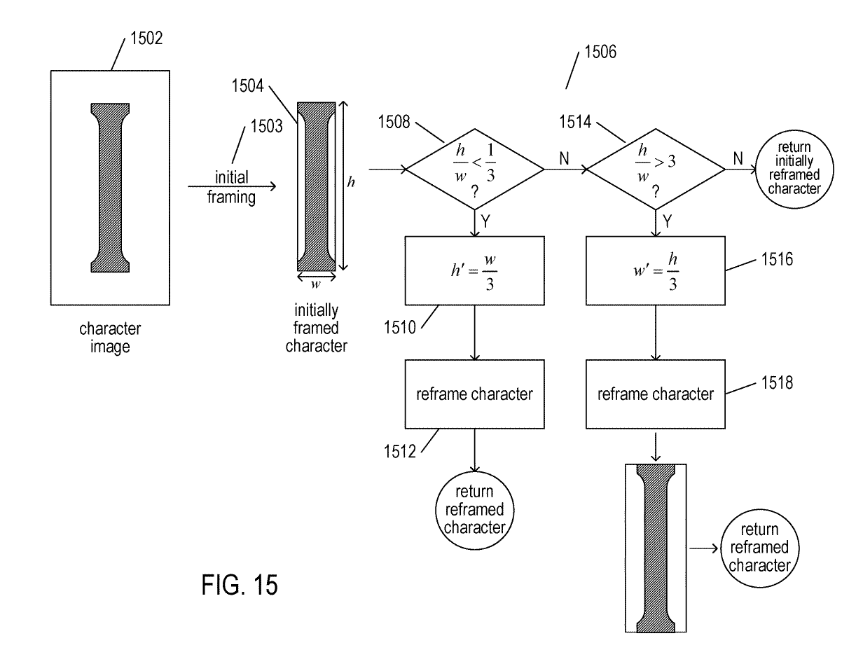

FIG. 15 illustrates a first step in the determination of the orientation of a character-containing subregion according to the methods to which the current document is directed. In FIG. 15, an initial character-containing subregion 1502 is shown to represent an example cell from a grid-superimposed text-containing region, such as text-containing region 1402 shown in FIG. 14A. In an initial framing step 1503, a rectangular frame 1504 is computed for the character-containing subregion that is minimal in size but that contains all of the 1-valued pixels within the character-containing subregion 1502. To facilitate this initial framing step, various types of noise-reduction processing can be carried out on the character-containing subregion 1502 to ensure that the initial framing does not produce a larger, suboptimal close-fitting frame because of noisy 1-valued pixels. The denoising can be carried out by a variety of different methodologies, including removal of 1-valued contiguous pixel regions of less than a threshold area. Then, as represented by the control-flow-diagram extract 1506 in FIG. 15, the initially framed character is further processed. Further processing is employed to ensure that the framed character is not too extended in either the vertical or lateral direction. When, as determined in step 1508, the ratio of the height of the initially framed character to the width of the initially framed character is less than a first threshold value, ⅓ in the example shown in FIG. 15, the height is increased, in step 1510, and the character is reframed with the new height, in step 1512. Otherwise, when, as determined in step 1514, the ratio of the height to the width of the initially framed character is greater than a second threshold value, 3 in the current example, the width is increased, in step 1516, and the character is reframed with the new width, in step 1518, to produce a reframed character 1520. As discussed below, the height or width adjustment may be constrained by the height and width of the character-containing subregion 1502, since width or height adjustments that would extend the borders of the reframed character 1520 past the borders of the character-containing subregion 1502 might inadvertently result in an overlap of the reframed character with the subregion of an adjacent character. Thus, the initial step shown in FIG. 15 creates a reasonably shaped and minimally sized frame to enclose the character in the character-containing subregion.

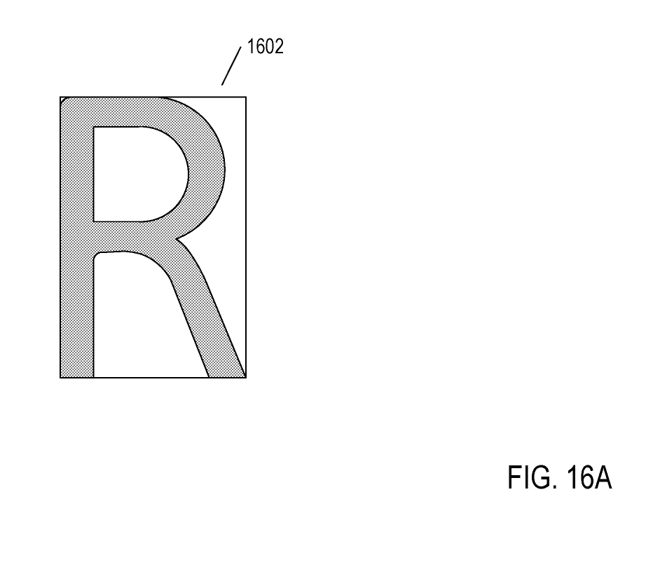

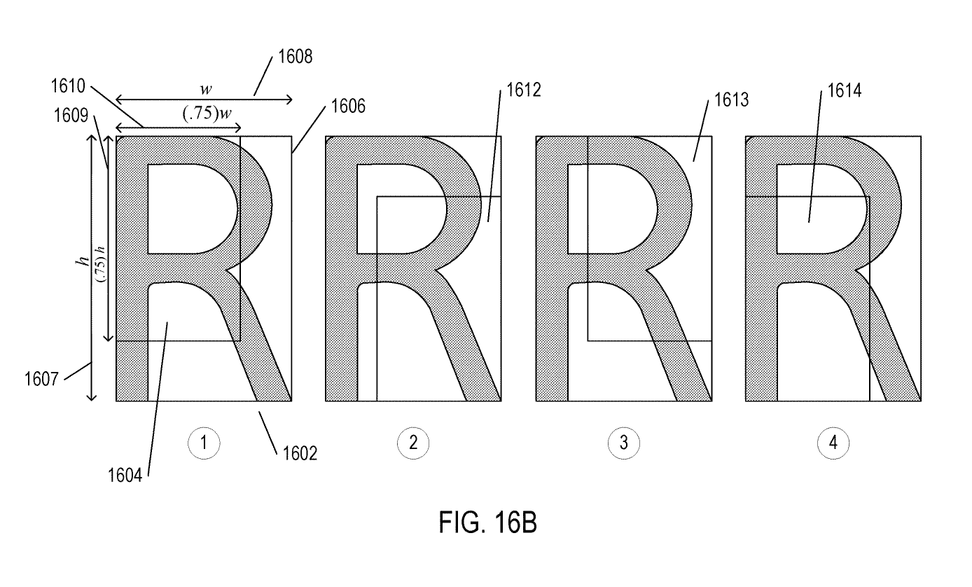

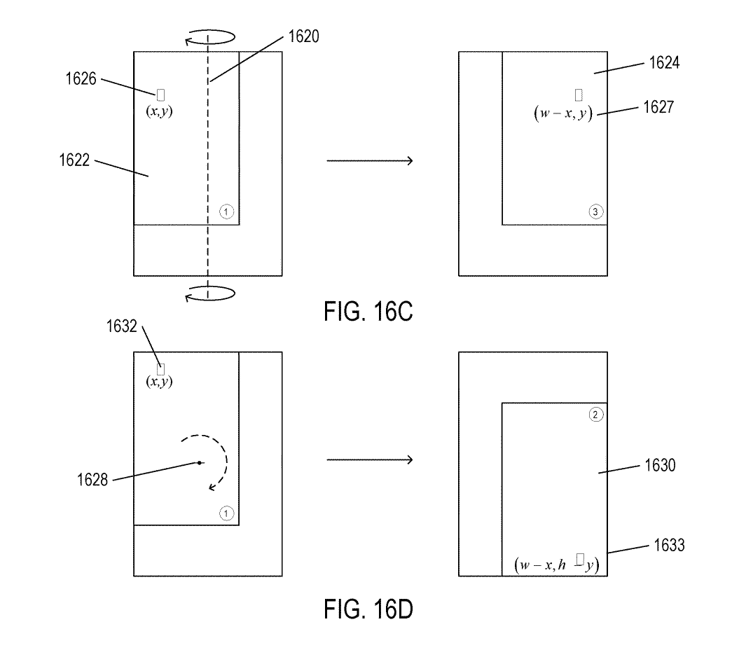

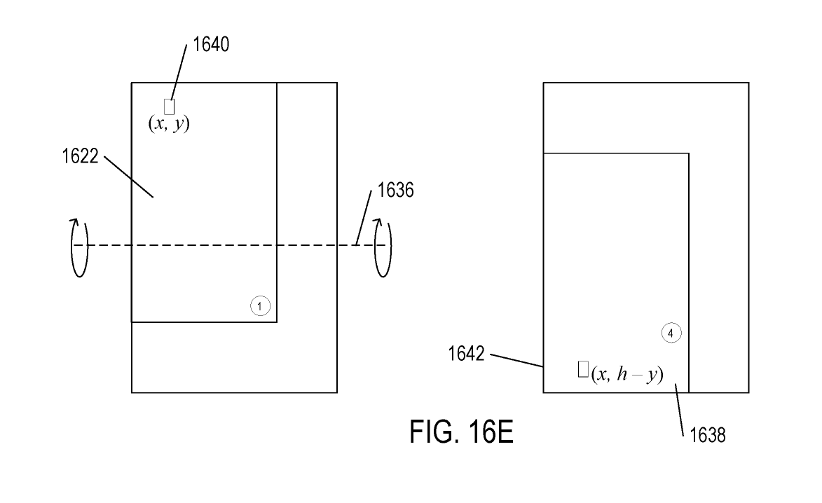

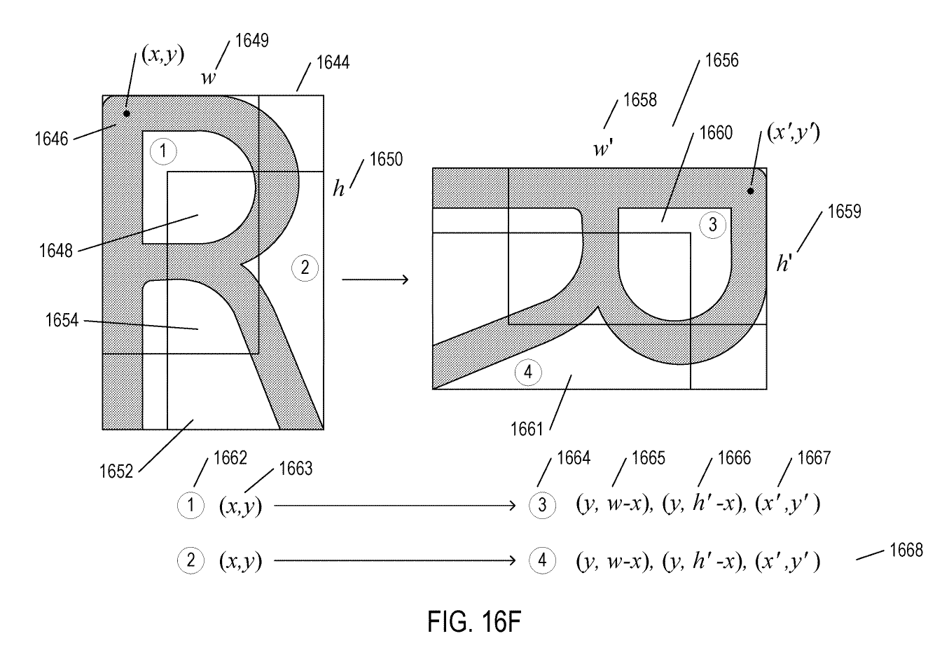

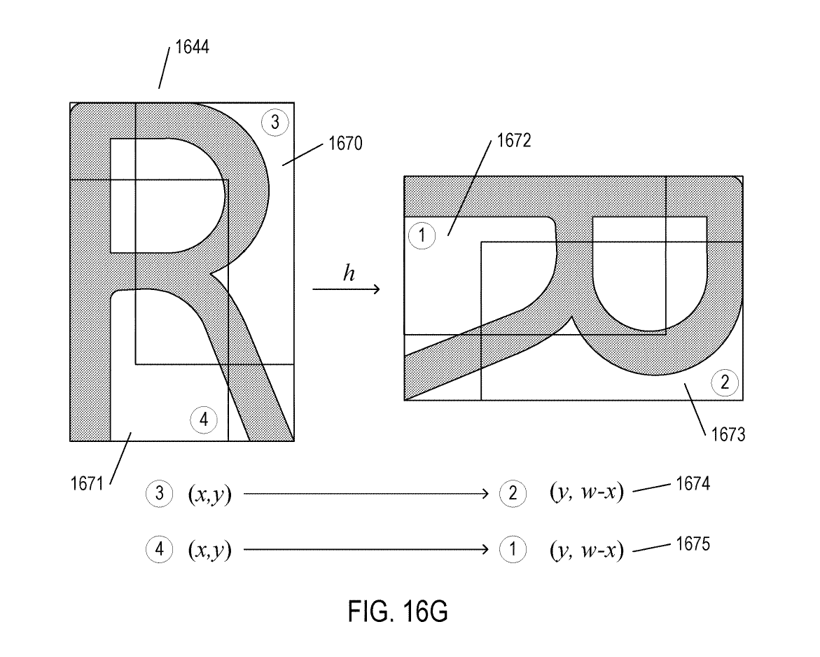

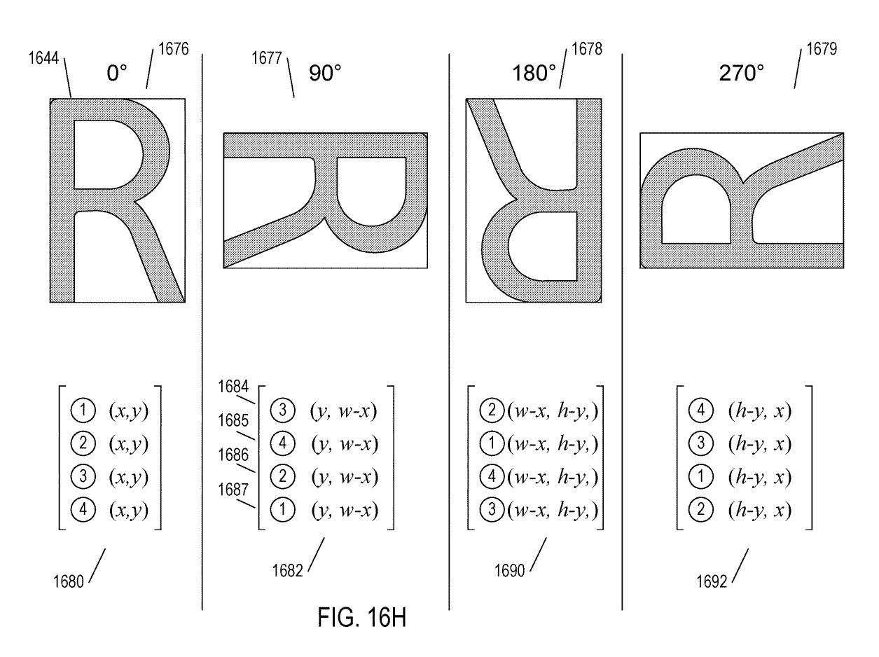

FIGS. 16A-H illustrate the use of framed-character subregions to compute metric-value vectors for a framed character. FIG. 16A shows an example framed character 1602. In the example case, the framed character is an “R” character. As shown in FIG. 16B, four different framed-character subregions are constructed for the framed character. The first framed-character subregion, indicated in FIG. 16B by the small rectangle 1604 within the frame 1606 of the framed character 1602, is constructed by generating subregion heights and widths of a known fraction of the heights and widths of the frame, 0.75 in the example shown in FIG. 16B. Thus, with the frame height h indicated by vertical arrow 1607 and the frame width w indicated by horizontal arrow 1608, the subregion height, indicated by vertical arrow 1609, has a length equal to 0.75 times the length of the frame height 1607 and the subregion width, represented by horizontal arrow 1610, has a length equal to 0.75 times the length of the frame width 1608. Note that the first subregion 1604 occupies the upper-left portion of the framed character 1606. Identically sized, but differently located additional framed-character subregions 1612-1614 are shown in FIG. 16B as occupying the lower-right, upper-right, and lower-left portions of the framed character, respectively. Thus, as shown in FIG. 16B, four overlapping framed-character subregions are constructed for each character-containing region.

The four framed-character subregions discussed above with reference to FIG. 16B are straightforwardly related to one another by simple symmetry operations. FIGS. 16C-E show simple symmetry operations that generate each of subregions 3, 2, and 4 from subregion 1. In FIG. 16C, a 180° rotation about a rotation axis, represented by dashed line 1620, lying in the plane of the framed-character subregion converts the framed-character subregion of type 1 1622 into a framed-character subregion of type 3 1624. The coordinates for a generalized point 1626 in the first subregion (x,y) becomes, following the symmetry transformation, (w-x,y) 1627 where w is the width of the framed character. The same coordinate-transformation operation can be used, with w′ equal to the width of the subregion, for coordinates with respect to the framed-character subregion, rather than the framed character. As shown in FIG. 16D, a 180° rotation or two-fold rotation about a rotation axis 1628 perpendicular to the plane of the framed character transforms the subregion of type 1 to a subregion of type 2 1630. In this case, the coordinate transformation changes the coordinates of a generalized point 1632 with coordinates (x,y) to the coordinates (w-x, h-y) 1633. Finally, as shown in FIG. 16E, rotation of the framed character about a horizontal two-fold rotation axis 1636 transforms the first s framed-character subregion 1622 to a subregion of type 4 1638. In this case, the coordinate transformation transforms the coordinates (x,y) for a generalized point 1640 to the coordinates (x, h-y) 1642.

FIGS. 16F-G illustrate the transformations of framed-character subregions attendant with rotations of a framed character. In FIG. 16F, a framed character 1644 is vertically positioned, which is arbitrarily assumed to represent a rotational state of 0°. A generalized point 1646 within a subregion of the first type 1648 is shown with generalized coordinates (x,y). The width of the framed character is iv 1649 and the height is h 1650. A framed-character subregion of type 1 (1648 in FIG. 16F) and a framed-character subregion of type 2 (1652 in FIG. 16F) are shown within the framed character. In this illustration, it is clear that the framed-character subregion of type 1 (1648 in FIG. 16F) and the framed-character subregion of type 2 (1652 in FIG. 16F) significantly overlap one another within the inner rectangular region 1654. Also in FIG. 16F, the framed character is shown rotated clockwise by 90° 1656. The 90° rotation results in the framed character having a new width w′ 1658 that is equal to the height h 1650 of the framed character in the 0° rotational state 1644. The rotated framed character also has a new height h′ 1659 equal to the width w of the character in the 0° rotational state 1644. The 90° rotation has converted what was a framed-character subregion of type 1 (1648 in FIG. 16F) into a framed-character subregion of type 3 (1660 in FIG. 16F) and has converted what was a framed-character subregion of type 2 (1652 in FIG. 16F) into a framed-character subregion of type 4 (1661 in FIG. 16F). In other words, as discussed above with reference to FIG. 16B, the type of the subregions is related to their position with respect to the size and corners of the frame. Following the 90° rotation, what was a framed-character subregion of type 1 (1648 in FIG. 16F) now occupies the upper-right-hand portion of the rotated framed character and therefore becomes a framed-character subregion of type 3 (1660 in FIG. 16F). FIG. 16F also shows the coordinate transformations of a generalized point. Thus, as indicated in the lower portion of FIG. 16F, the framed-character subregion of type 1 (1662 in FIG. 16F) with a generalized point having coordinates (x,y) 1663 is transformed into a framed-character subregion of type 3 (1664 in FIG. 16F) with coordinates (y, w-x) 1665, alternately expressed as (y, h′-x) 1666 using the new height h′ of the rotated character frame, or as (x′,y) 1667 in terms of the rotated framed character. The final line 1668 of FIG. 16F indicates that the framed-character subregion of type 2 is converted into a framed-character subregion of type 4 by the 90° rotation of the character frame, with the same coordinate transformation. FIG. 16G, using the same illustration conventions as used in FIG. 16F, illustrates the transformations of framed-character subregions 1670 and 1671 of types 3 and 4 within the framed character 1644 in the 0° rotational state to framed-character subregions of type 1 (1672 in FIG. 16G) and type 2 (1673 in FIG. 16G) by the 90° rotation of the framed character. These transformations are indicated in lines 1674-1675 in the lower portion of FIG. 16G using the same conventions as used to express the transformations in FIG. 16F.

FIG. 16H illustrates the subregion transformations for all four orientations of a framed character. In FIG. 16H, the four orientations of a framed character 1644 are shown in each of four columns 1676-1679. These include 0°, 90°, 180°, and 270° rotational states, respectively, of the framed character. A vector-like map, such as vector-like map 1680, is shown below each framed character in FIG. 16H. The vector-like maps indicate the framed-character-subregion-type transformations and coordinate transformations for each rotational state, as discussed above with reference to FIGS. 16F-G. The first vector-like map 1680 indicates that, in the 0° rotational state, the framed-character-subregion types and coordinates are considered to be not transformed. The elements in all of the vector-like maps are ordered, top-down, with respect to framed-character-subregion types 1, 2, 3, and 4 of the framed character in the 0° rotational state. In other words, the elements in a vector-like map are ordered, or indexed, by the identities of the framed-character-subregions in the 0° rotational state. The 90° rotational state shown in column 1677 includes a vector-like map 1682 that indicates, as discussed above with reference to FIGS. 16F-G, that what was previously a framed-character subregion of type 1 is now a framed-character subregion of type 3 (1684 in FIG. 16H), what was previously a framed-character subregion of type 2 is now a framed-character subregion of type 4 (1685 in FIG. 16H); what was previously a framed-character subregion of type 3 is now a framed-character subregion of type 2 (1686 in FIG. 16H), and what was previously a framed-character subregion of type 4 is now a framed-character subregion of type 1 (1687 in FIG. 16H). Thus, the vector-like map 1682 shows the new framed-character-subregion types, following a 90° rotation, of the framed-character-subregions in the 0° rotational state. Vector-like maps 1690 and 1692 show the new types for the framed-character-subregions in the 0° rotational state following rotation of the 0° -rotational-state framed-character-subregion 1644 by 180° and 270°, respectively. In other words, the order of the elements in all of the vector-like maps corresponds to the numerical order of the framed-character subregions for the framed character in the 0° rotational state, but the type numbers and coordinates in the element refer to what the framed-character subregion has become following the rotation with which the vector-like map is associated.

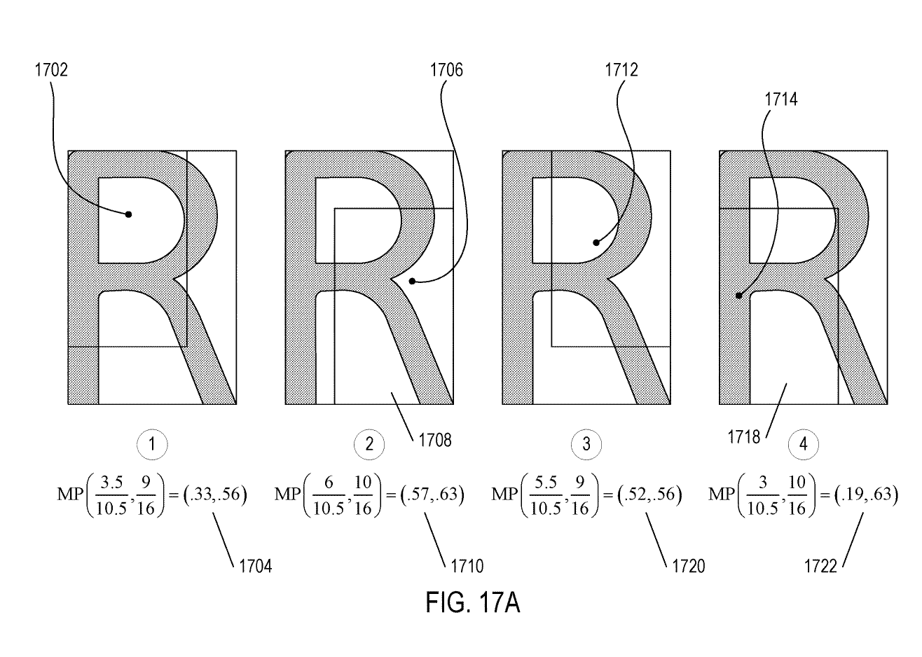

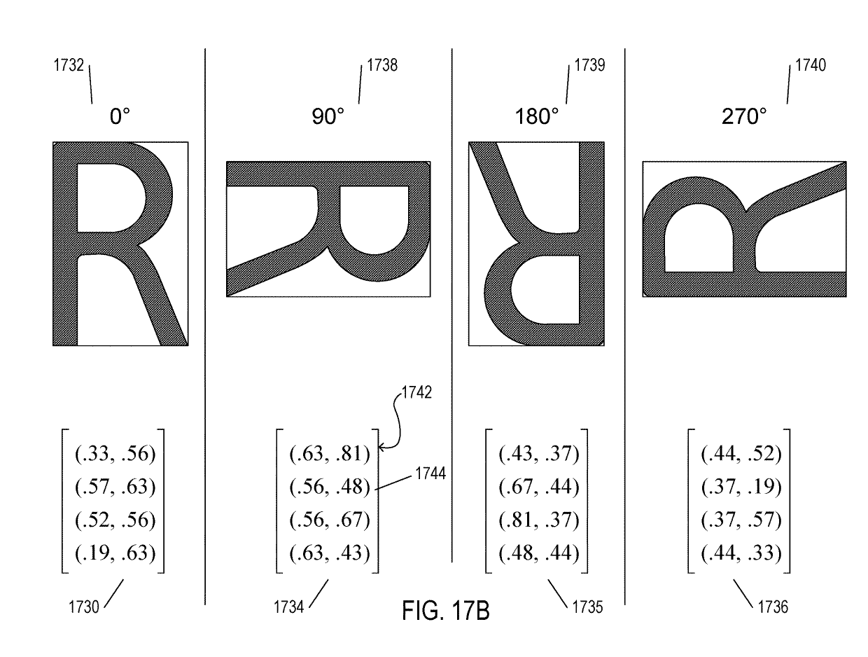

The symmetry transformations discussed above with reference to FIGS. 16A-H provide the basis for computationally efficient metric-value transformations that allow the metric values computed for a framed character in a first rotational state to be computationally transformed into corresponding sets of metric values for the other three rotational states for the framed character, without requiring full re-computation of the metric values from the pixel values in the framed character and without requiring computational rotation of the framed character itself. FIGS. 17A-B illustrate an example metric-value transformation. The example metric is the median-point metric (“MP”). The x coordinate for the median point of a subregion is the point at which there is an equal number of black pixels to the left of the point as there are to the right of the point. They coordinate for the median point is the y-coordinate value above which there are an equal number of black, or 1-value pixels, as there are below they coordinate value. Clearly, computation of the MP metric for a framed-character subregion involves consideration of all of the pixels within the framed-character subregion, and, although mathematically simple, is computationally non-trivial. As shown in FIG. 17A, the median point for the first framed-character subregion 1702 of type 1 has coordinates (0.33, 0.56) 1704. The median point 1706 for the framed-character subregion of type 2 (1708 in FIG. 17A) has coordinates (0.57, 0.63) 1710. The median points 1712 and 1714 for the framed-character subregions of type 3 and type 4, 1716 and 1718, have coordinates (0.52, 0.56) 1720 and (0.19, 0.63) 1722, respectively. Thus, as shown in FIG. 17A, for each framed-character subregion, a different median point with different coordinates is computed to generate four metric values for the median-point metric for the framed character. As shown in FIG. 17B, these four metric values are arranged in a metric-value vector 1730 for the 0° rotational state of the framed character 1732. Now, based on the vector-like maps discussed above with reference to FIG. 16H, the corresponding metric-value vectors 1734-1736 for the 90°, 180°, and 270° rotational states, 1738-1740 respectively, of the framed character can be straightforwardly computed. The coordinates shown for the median points in FIG. 17A are expressed in terms of relative coordinates that range both for the x and y axes of the framed-character subregions from 0 to 1. Therefore, a transformation such as w-x is obtained by subtracting x from 1. As one example, in order to compute the median point for the framed-character subregion of type 1 for the 90°-rotational-state framed-character 1738, the fourth metric value from the 0°-rotational-state metric-value vector 1730 is selected, as indicated by entry 1687 in the vector-like map 1682 in FIG. 16H, and the coordinates within the selected fourth metric value are transformed according to the transformation shown in the vector-like map 1682 in FIG. 16H to produce a median-point value for the framed-character subregion of type 1 for the 90° rotational state of (0.63, 0.81) 1742. Similarly, according to vector-like map 1682, the median point for the framed-character subregion of type 2 in the 90° rotational state 1744 is obtained from the median point for the framed-character subregion of type 3 in the 0° rotational state with the appropriate coordinate transformation indicated in vector-like map 1682. Thus, the three metric-value vectors 1734-1736 are obtained by re-ordering the metric values in the metric-value vector 1730 and then applying the appropriate coordinate transformations to the rearranged values. This is, of course, far easier, computationally, than re-computing the median-point values based on pixel values in computationally rotated character frames.

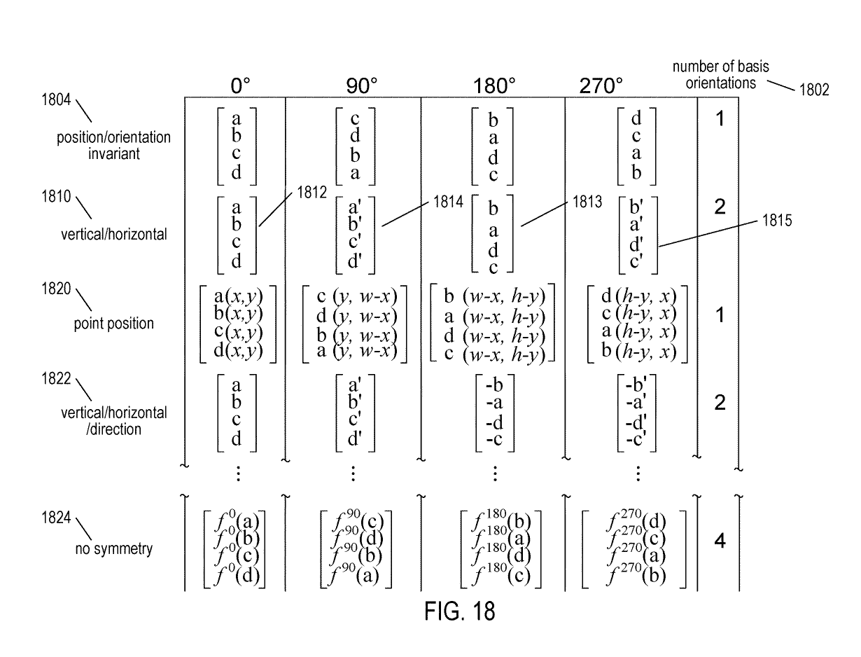

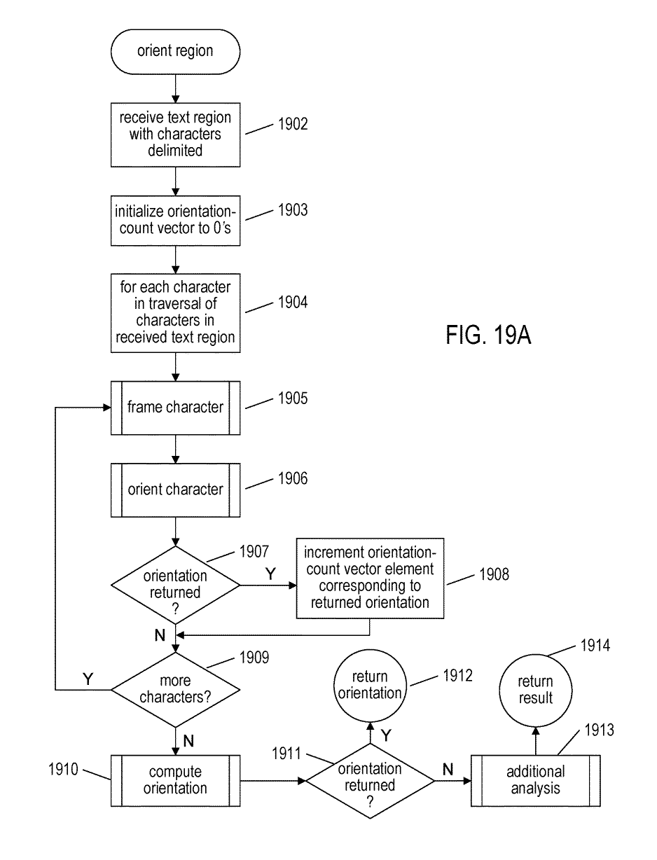

There are many different possible metrics that can be computed for subregions of a framed character, and these metrics generally fall into one of a variety of different transformation classes. FIG. 18 provides a table that shows a small number of example transformation classes. The transformation classes are represented by rows in the table and the first four columns of the table correspond to rotational states. The number of basis orientations for the transformation class is shown in a final column 1802. The first transformation class 1804 corresponds to those metrics that are position-and-orientation invariant. An example of such a metric is the percentage of 1-valued pixels within a subregion. The percentage does not change when the subregion is rotated. Therefore, the vector-like maps for this transformation class, such as vector-like map 1806, indicate the new types of the 0°-rotational-state framed-character subregions following rotations of 0°, 90°, 180°, and 270°. Only one orientation of the framed character is needed to generate all four sets of metric values, as a result of which there is only one basis orientation. A second example transformation class 1810 includes those metrics that are differently calculated for the 0° and 180° rotational states, on one hand, and the 90° and 270° rotational states, on the other hand. One example would be the largest vertical column of 1-value pixels within the subregion. The value for that metric is the same for the 0° and 180° rotational states, but is different and differently calculated for the 90° and 270° rotational states. Thus, there is a first set of related vector-like maps 1812 and 1813 for the 0° and 180° rotational states and a second set of vector-like maps 1814 and 1815 for the 90° and 270° rotational states. The framed-character-subregion transformations are carried out by re-ordering metric values within a metric-value vector, but there are two different basis orientations for the two different sets of vector-like maps. A third transformation class 1820 includes those metrics that correspond to points at a computed position within a subregion. The median-point metric, discussed above with reference to FIGS. 17A-B, is an example of a metric that falls in this transformation class. In this case, the vector-like maps include both indications of re-ordering of the metrics for framed-character subregions as well as for coordinate transformations. Yet another transformation-class example 1822 is a metric that is differently calculated for 0° and 180° rotational states than for 90° and 270° rotational states, such as the vertical/horizontal transformation class 1810 discussed above. However, in this case, a direction is also involved. An example metric of this transformation class might be the longest vertical column of 1-valued pixels followed by 0-valued pixels, with a direction associated with the metric corresponding to the direction from the 0-valued pixels to the 1-valued pixels. The vector-like maps for this transformation class are similar to those for the vertical/horizontal transformation class 1810, with the exception that not only are the subregion values interchanged, but the signs of the metric values are also changed. A final transformation class shown in the table of FIG. 18 1824 corresponds to a metric for which there is no symmetry-based transformation. For such metrics, the metric values must be re-computed from pixel values for each subregion for each rotational state. This is indicated in the vector-like maps for this transformation class by functional notation where the argument to the functions is the framed-character subregion. Clearly, to use the method described above with reference to Figure E, the metrics need to belong to transformation classes that have two basis orientations, while to use the method described above with reference to FIG. 14F, the metrics need to belong to transformation classes that have a single basis orientation. Below, a more general, mixed-transformation-class method is described.

Although it is possible, as discussed below, to use different sets of orientation characters, each set corresponding to orientation characters associated with a different number of basis orientations, it is also possible, in alternative implementations, to use only a single set of metric values for each orientation character, as in FIG. 14F. For those orientation characters with two basis orientations, each of the two orientation-character/orientation pairs can be considered a different orientation character. Alternatively, when the metrics for the currently considered character-containing subregion are transformed, the metric values in the set of metric values associated with an orientation character that is associated with multiple basis orientations can be correspondingly transformed, or recomputed from the orientation-character image. Alternatively, for certain transformations of the character-containing subregion corresponding to particular rotations, the metric values associated with one orientation-character/orientation pair of each orientation character having two basis orientations and the transformed metric values for the character-containing subregion may be projected to include only metric values that can be sensibly transformed for the particular rotations. In other words, in the case that most metrics are associated with only a single basis orientation, the exceptional metrics associated with two basis orientations can be handled differently, as special cases, to avoid a need for redundantly storing multiple sets of metric values for all of the orientation characters or for the additional complexity of the generalized method discussed below.

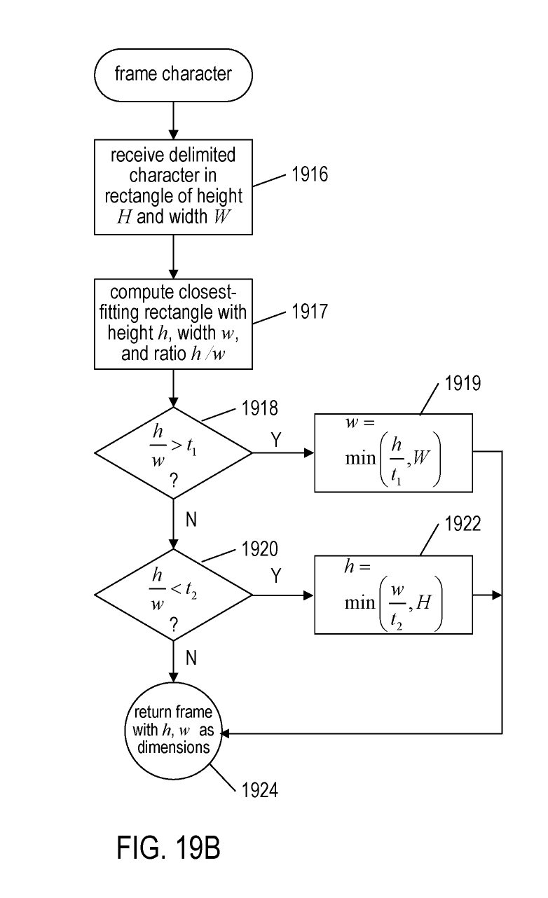

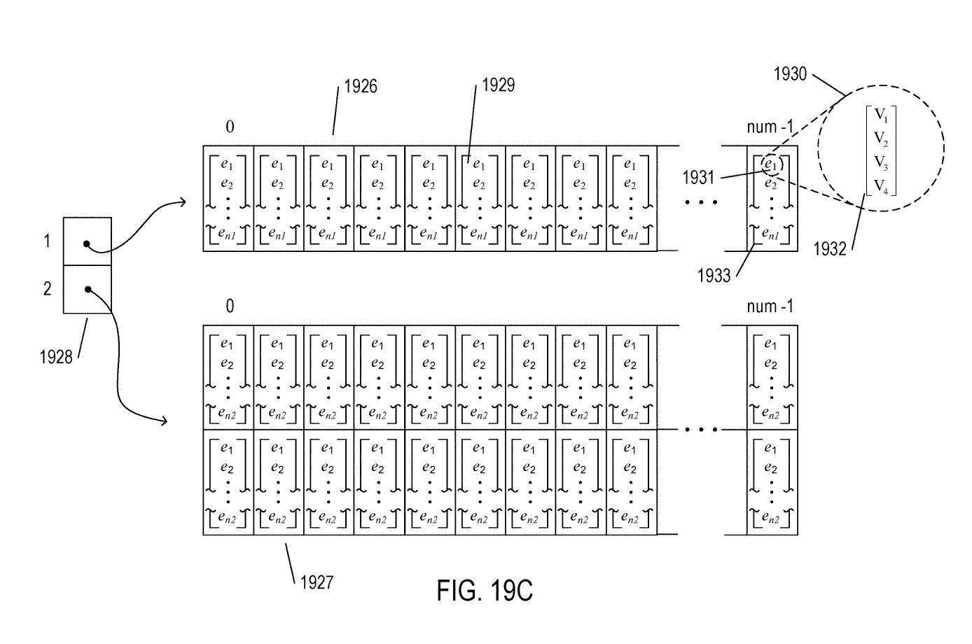

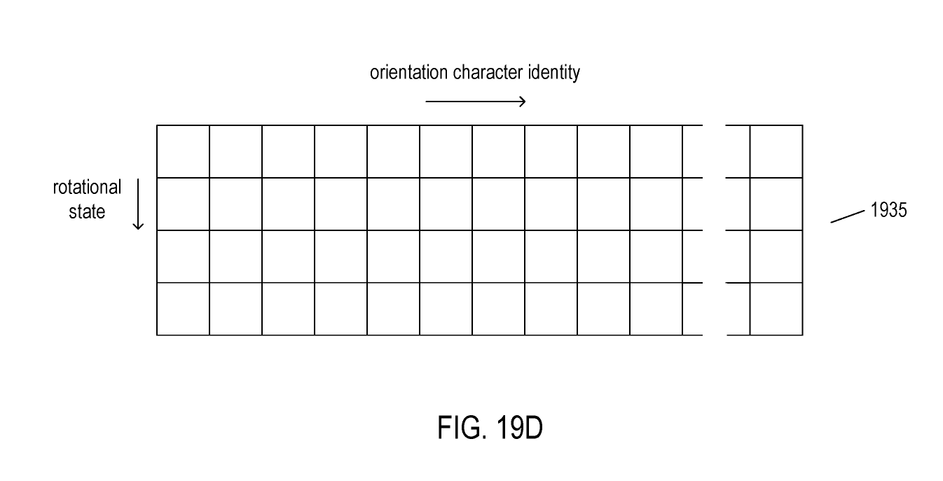

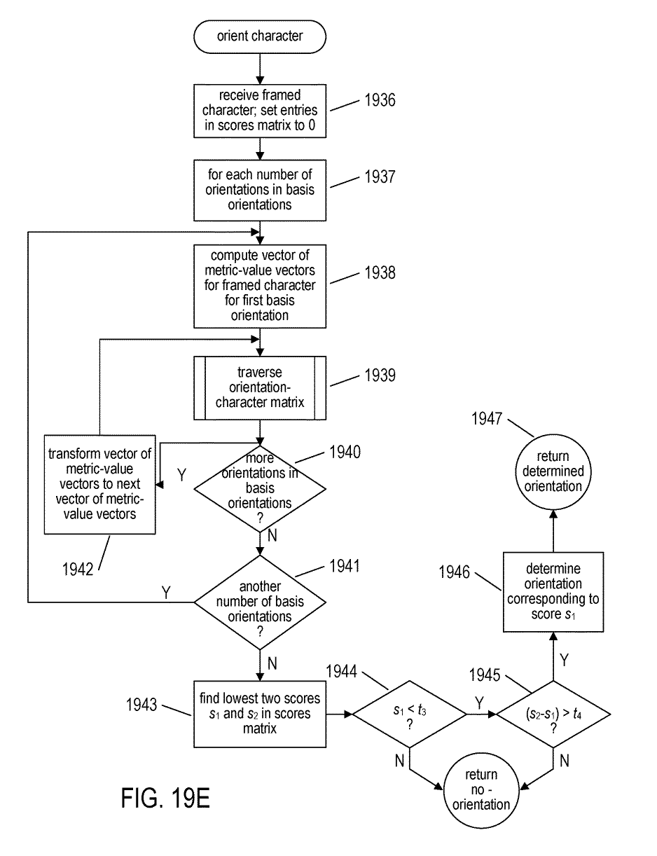

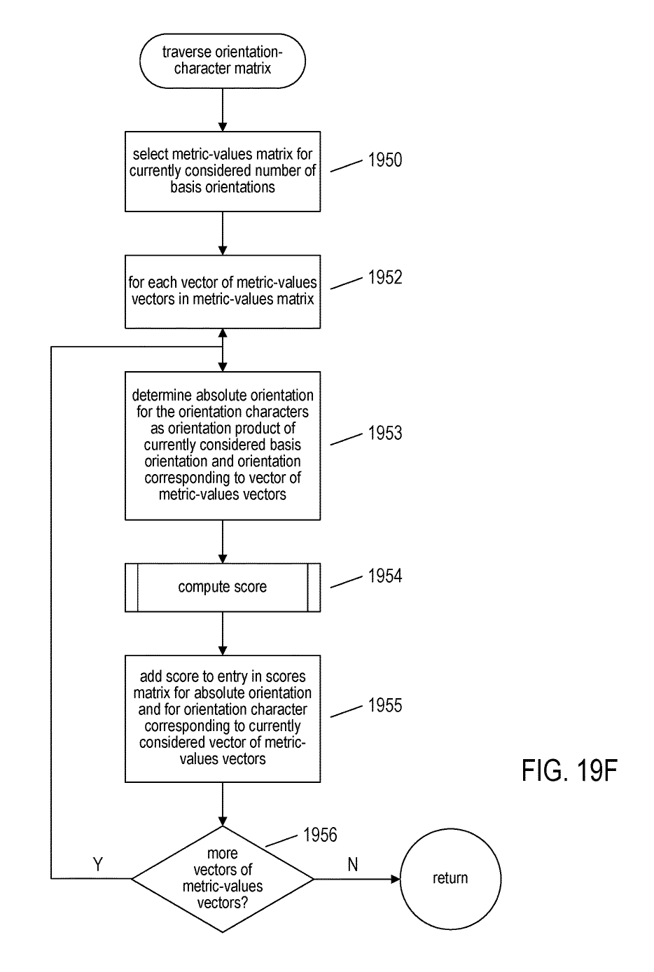

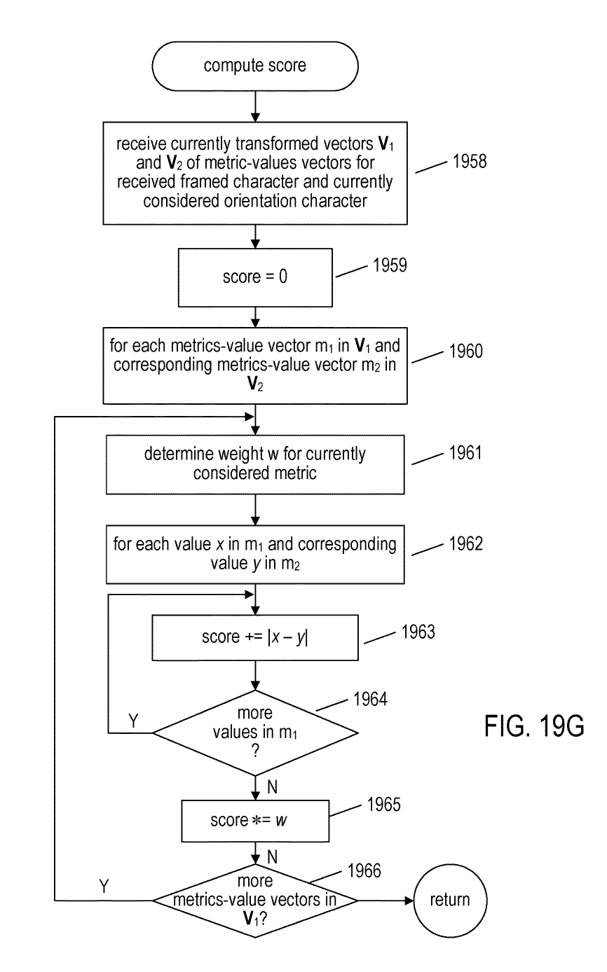

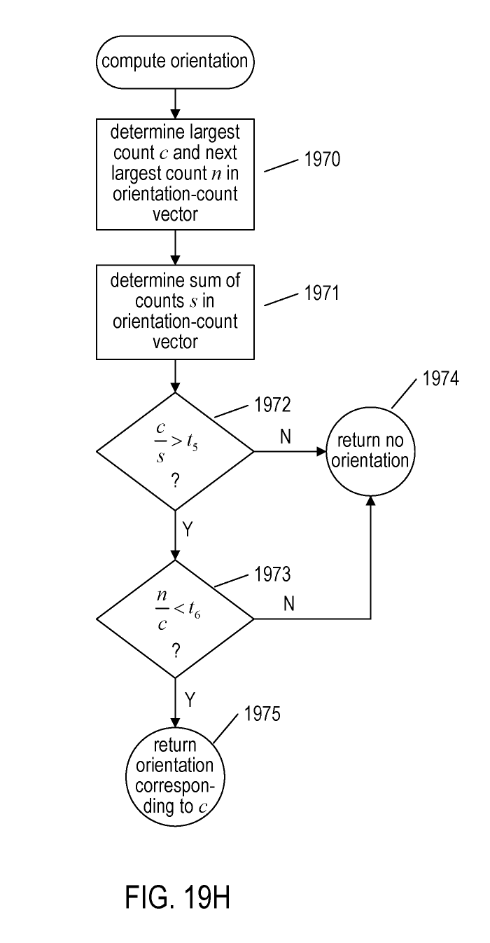

FIGS. 19A-F provide control-flow diagrams that illustrate a generalized text-containing-region orientation method that encompasses the methods discussed above with reference to FIGS. 14E and F. FIG. 19A provides a high-level control-flow diagram for the routine “orient region.” In step 1902, the routine receives a text-containing region with characters already delimited, such as text-containing region 1402 in FIG. 14A. In step 1903, an orientation-count vector with elements corresponding to the four different possible rotational orientations 0°, 90°, 180°, and 270° is zeroed. In the for-loop of steps 1904-1909, each character-containing region in the received text-containing region is considered in a traversal, as discussed above with reference to FIG. 14B. For each character-containing subregion, the character is framed, by a call to a frame-character function in step 1905, and then oriented, by a call to an orient-character function 1906. When an orientation is returned by the orient-character function 1906, the value in the element of the orientation-vector corresponding to the returned orientation is incremented, in step 1908. In step 1910, a call to a compute-orientation function is made to determine the orientation of the text-containing region from the counts accumulated in the orientation-count vector. When this routine returns an orientation, as determined in step 1911, then that orientation is returned as the orientation of the text-containing region of step 1912. Otherwise, an additional analysis step 1913 is carried out and the result of that analysis is returned in step 1914. Many different types of additional analyses may be carried out, including consideration of pairs of adjacent characters with respect to observed character-pair frequencies for a natural language, attempting to match common words to character sequences, and other such analyses.

FIG. 19B provides a control-flow diagram for the frame-character function called in step 1905 of FIG. 19A. In step 1916, a delimited character-containing region is received with a height H and a width W. In step 1917, a closest-fitting rectangle with height h and width w is constructed, as discussed above with

$$\frac{h}{w}$$

reference to FIG. 15, and the ratio is computed. When the computed ratio is greater than a first threshold t₁, as determined in step 1918, the width of the closest-fitting rectangle is adjusted to be the minimum of 1/t₁ of the height or to be the width of the received delimited character W in step 1919, whichever is smaller. Otherwise, when the ratio is less than a second threshold t₂, as determined in step 1920, then the height of the closest-fitting rectangle is adjusted to be the minimum of 1/t₂ the width or to be the height of the original received delimited character-containing region H, in step 1922. A frame with height h and width w constructed from the closest-fitting rectangle is returned, in step 1924, as discussed above with reference to FIG. 15. In alternative implementations, additional steps involving changing both the height and width of the closest-fitting rectangle may be employed when, after steps 1918-1922, the closest-fitting rectangle is still too extended.

As discussed above with reference to FIGS. 14D-F, determining the orientation of a character involves traversing a set of orientation characters, comparing metric values for a currently considered framed character with the metric values for each orientation character, to generate scores for each orientation of each orientation character. Then, the best score of the scores is selected and, when the score satisfies certain conditions, the orientation of the orientation character associated with the score is selected as the orientation of the framed character. In the previously described method, as discussed above with reference to FIG. 14D, metric values for all four possible orientations of the orientation characters are precomputed and stored to facilitate a traversal through the stored metric values in order to compare the framed character with each possible orientation of each orientation character. However, as discussed above with reference to FIGS. 14E-F, the current application is directed to memory-efficient methods in which the metric values computed for the framed character are transformed to reflect rotations of the framed character, with a separate traversal for each transformation, of a smaller number of stored metric values for the orientation characters. The currently described method is a generalized method that includes aspects of the methods discussed above with reference to FIGS. 14E and F. In this generalized method, the metrics are partitioned into a set of metrics for which there is a single orientation in the orientation basis, as discussed above with reference to FIG. 18, and a set of metrics for which there are two orientations in the orientation basis. Metric values for the orientation characters for these two different classes of metrics are stored in two different matrices. These are separately traversed for efficiency, one requiring four transformation of the framed-character metric values for which an orientation is sought, and one requiring two transformations of the framed-character metric values. The generalized method is, in fact, even more generalized in the sense that it can accommodate any metric classes with any arbitrary number of orientations in the orientation basis.

FIG. 19C illustrates the stored metric values for the orientation characters. A first metrics-values matrix 1926 stores metric values for those metrics associated with an orientation basis containing a single orientation, such as the metrics discussed above with reference to FIG. 14F and rows 1804 and 1820 in the table shown in FIG. 18. This matrix has a single row and is therefore essentially an array. A second metrics-values matrix 1927 contains two rows and is used for metrics for which the orientation basis has two orientations, as discussed above with reference to FIG. 14E and rows 1810 and 1822 in FIG. 18. References to the two metrics-values matrices are contained in a small reference array 1928, the entries of which are indexed by the number of orientations in the orientation basis. Each cell in a metrics-values matrix, such as cell 1929 in metrics-values matrix 1926, includes a vector of metric-values vectors. These are the metric-values vectors for each of the n1 metrics belonging to the class of metrics associated with the metrics-values matrix. As shown by inset 1930, which provides details for element 1931 in the vector of metric-values vectors 1932, each element in the vector of metric-values vectors, such as element 1931, is itself a vector 1932 with four values for a particular metric computed for the four different subregions of the orientation character in a particular rotational state, as discussed above with reference to FIGS. 16A-17B. The columns of the two metrics-values matrices 1926 and 1927 are aligned and commonly indexed by orientation-character identifier. In general, the number of elements n1 in the vector of metric-values vectors in a cell of metrics-values matrix 1926 is different from the number of elements n2 in the vectors of metric-values vectors in the cells of the metrics-values matrix 1927. Again, the number of elements in a vector of metric-values vectors is equal to the number of metrics in the metrics class corresponding to the metrics-values matrix. As can be seen by the potentially many different possible metrics values stored in each cell of the metrics-values matrices, the currently described methods, which significantly decrease the number of rows in the metrics-values matrices stored in memory, as discussed above with reference to FIGS. 14D-F, significantly lowers the memory overhead for text-containing-region orientation. As shown in FIG. 19D, the scores produced by the metrics-values-matrices traversals are stored in a single score matrix 1935 with columns indexed by the identity of orientation characters and rows indexed by the rotational state, as discussed above with reference to FIGS. 14D-F.

FIG. 19E provides a control-flow diagram for the orient-character routine called in step 1906 of FIG. 19A. In step 1936, the orient-character routine receives the framed character that is to be oriented, or a reference to the framed character, and sets the entries in the scores matrix, discussed above with reference to FIG. 19D, to 0. In the for-loop of steps 1937-1942, each of the different classes of metrics, differentiated by the number of orientations in the basis orientation, is considered. For each class of metrics, a vector of metric-values vectors for the received framed character is computed for the first basis orientation, in step 1938. In step 1939, this vector of metric-values vectors is then used in a traversal of the metrics-values matrix, or orientation-character matrix, for the metric class, such as matrices 1926 and 1927 discussed above with reference to FIG. 19C. When there are more orientations in the orientation basis, as determined in step 1940, the vector of metric-values vectors for the framed character is transformed, in step 1942, according to transformation rules, such as those discussed above with reference to FIGS. 17A-18. Control then returns to step 1939 for another traversal of the orientation-character matrix for the metric class. The transformation step is equivalent to a rotation of the framed character, as discussed above with reference to FIGS. 14E-F. When there are no more orientations in the orientation basis, as determined in step 1940, then, when there are additional metric classes to consider, as determined in step 1941, control turns to step 1938. When all of the metrics-values matrices have been traversed for all needed rotations of the framed character, the two lowest scores s₁ and s₂ are found in the scores matrix, in step 1943. When the lowest score is less than a first threshold value, t₃, as determined in step 1944, and when the difference between the next-lowest score and the lowest score is greater than a second threshold value, t₄, as determined in step 1945, the orientation corresponding to the lowest score s₁ is selected as the orientation for the received framed character, in step 1946, and that orientation is returned in step 1947. The orientation is indicated by the orientation or rotational-state index of the row in which the score occurs within the scores matrix. When the tests in either of steps 1944 and 1945 fail, an indication of no orientation is returned. Of course, there may be other criteria used to select the orientation of a character based on the scores stored in the scores matrix, and, as discussed further below, there may be scoring methods other than those shown for the described implementation. As one example, rather than insisting that the determinative score be separated from the next most determinative score by a threshold difference, a more complex criterion may be to identify the orientation with the best score and require that the best score associated with that orientation be separated by a threshold distance from the best score associated with any other orientation.

FIG. 19F provides a control-flow diagram for the traverse-orientation-character-matrix routine called in step 1939 of FIG. 19E. In step 1950, the metrics-values matrix, or orientation-character matrix, corresponding to the currently considered number of basis orientations, or iteration of the for-loop of steps 1937-1942 in FIG. 19E, is selected. Then, in the for-loop of steps 1952-1956, the selected metrics-values matrix is traversed. In step 1953, the absolute orientation for the orientation character corresponding to the currently considered vector of metric-values vectors, or entry in the metrics-values matrix, is determined as the orientation product of the currently considered basis orientation for the framed character and the orientation corresponding to the currently considered vector of metric-values vectors, as discussed above with reference to FIGS. 14E-F. For example, when the currently considered framed-character rotational state is 180° and the orientation of the orientation character is 90°, then the absolute orientation of the orientation character is 270°. Next, in step 1954, a score is computed by comparing the vector of metric-values vectors computed for the framed character and the currently considered vector of metric-values vectors of an orientation character by a call to the compute-score function. Then, in step 1955, the computed score is added to the entry in the scores matrix corresponding to the absolute orientation determined in step 1953 and the orientation character corresponding to the currently considered vector of metric-values vectors. When there are more vectors of metric-values vectors to consider, as determined in step 1956, control returns to step 1953. Otherwise, the traverse-orientation-character-matrix routine returns.

FIG. 19G provides a control-flow diagram for the compute-score routine called in step 1954 of FIG. 19F. In step 1958, the compute-score routine receives the vector of metric-values vectors for the framed character, V₁, and the currently considered vector of metric-values vectors for an orientation character, V₂. In step 1959, a local variable score is set to 0. In a for-loop of steps 1960-1966, each corresponding pair of metric-value vectors m₁ and m₂ in vectors V₁ and V₂ is considered. In step 1961, a weight w for the currently considered metric is determined. As discussed above, each element in a vector of metric-values vectors corresponds to a metric, and, in certain implementations, each metric is associated with a weight. In the inner for-loop of steps 1962-1964, the absolute value of the difference between each pair of framed-character-subregion metric values and orientation-character metric values in the currently considered metric-values vectors is computed and added to the score. In step 1965, the score is multiplied by the weight w.

To summarize FIGS. 19F and G, the generalized text-containing-region orientation method compares each metrics-values set computed for a character-containing subregion to each metrics-values set in the one or more sets of orientation-character metrics-values sets to generate a score is combined with a score in a result set of scores. For each orientation-character/orientation pair for which a metrics-values set is stored, the generalized text-containing-region orientation method compares the metric-values set for the rotational state of the character-containing subregion to the metrics-values set for the orientation-character/orientation pair to generate a score, combines the basis orientation of the orientation-character/orientation pair and rotational state to generate an orientation, identifies a score in a set of scores corresponding to the orientation character and generated orientation, and modifies the identified score to have a new value obtained by combing the current value of the identified score with the generated score.

FIG. 19H provides a control-flow diagram for the compute-orientation routine called in step 1910 of FIG. 19A. In step 1970, the largest count c and the next-largest count n of the counts in the orientation-count vector are determined. In step 1971, the sum of the counts in the orientation-count vectors is determined. When the ratio c/s is greater than a first threshold t₅, as determined in step 1972, then an indication that no orientation was computed is returned in step 1974. Alternatively, when the ration n/c is less than a second threshold t₆, as determined in step 1973, then the orientation corresponding to the element having count c is returned in step 1975.

Although the present invention has been described in terms of particular embodiments, it is not intended that the invention be limited to these embodiments. Modifications within the spirit of the invention will be apparent to those skilled in the art. For example, any number of different implementations of the currently disclosed orientation-marker-character-based text-containing-image-region orientation method can be obtained by varying any of many different implementation and design parameters, including programming language, operating system, data structures, control structures, variables, modular organization, and other such design and implementation parameters. As discussed above, any of a wide variety of different methods and metrics can be used to identify orientation characters in a text-containing-image region and to determine the orientations of these orientation characters. A variety of different thresholds can be used to determine when an orientation character matches with a character image and to determine when an orientation for the text-containing region can be ascertained based on counts of orientation-marker-character orientations recognized in the text-containing region. Although the above-discussed and above-illustrated orientation method and routine determines an orientation for a text-containing region, the above-discussed method may be applied to various different types and sizes of regions, including single text lines or columns, blocks of text characters, entire pages of text, and other types of text-containing regions. In the above-described method, each text-character in a text-containing region is attempted to be matched by each possible orientation of each orientation character, but, in alternative methods and systems, only a portion of the text-characters in a text-containing region may need to be attempted to be matched by each possible orientation of each orientation character, the portion determined by a probability of the orientation being uniquely determined from the portion exceeding a threshold value.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An image processing system that determines an orientation for a text-containing region of an image, the image processing system comprising:
one or more processors;
one or more electronic memories;
one or more mass-storage devices;
one or more sets of orientation-character metrics-values sets stored in one or more of the one or more electronic data storage devices; and
computer instructions stored in the one or more electronic data storage devices that control the image processing system to
receive an image with a text-containing region,
store a representation of the text-containing region in one or more of the one or more electronic memories,
identify a number of character-containing subregions within the text-containing region that each matches an orientation-character/orientation pair by comparing one or more metrics-values sets computed for each of two or more rotational states of the character-containing subregion to metrics-values sets stored for each orientation character in the one or more sets of orientation-character metrics-values sets, and
determine an orientation for the text-containing region from the orientations of the number of character-containing subregions that each matches an orientation-character/orientation pair.

2. The image processing system of claim 1 wherein the number of orientation characters is less than 10% of the total number of characters for a language of the text-containing region.

3. The image processing system of claim 1 wherein the number of orientation characters is less than 1% of the total number of characters for a language of the text-containing region.

4. The image processing system of claim 1 wherein the number of orientation characters is less than 0.1% of the total number of characters for a language of the text-containing region.

5. The image processing system of claim 1
wherein each set of orientation-character metrics-values sets corresponds to a set of metrics having a common number of basis orientations;
wherein each set of orientation-character metric-values sets includes a metrics-values set for each orientation character in each basis orientation for the set of orientation-character metrics-values sets; and
wherein each metrics-values set includes a set of metric values for each metric.

6. The image processing system of claim 5 wherein the image processing system identifies the number of character-containing subregions within the text-containing region that each matches an orientation-character/orientation pair by:
for each character-containing subregion within the text-containing region,
initializing a set of scores containing a score for each orientation-character/orientation pair,
for each rotational state of the character-containing subregion that is used, in combination with a basis orientation of an orientation character, to determine the orientation of the orientation character with respect to the text-containing region,
for each set of metrics having a common number of basis orientations,
computing a metrics-values set,
comparing each metrics-values set computed for the character-containing subregion to each metrics-values set in the one or more sets of orientation-character metrics-values sets to generate a score that is combined with a score in the set of scores;
when a score in the set of scores indicates that the orientation-character/orientation pair corresponding to the score matches the character-containing subregion, returning the orientation of the orientation-character/orientation pair associated with the score as the orientation of the character-containing subregion.

7. The image processing system of claim 6 wherein comparing each metrics-values set computed for the character-containing subregion to each metrics-values set in the one or more sets of orientation-character metrics-values sets to generate a score that is combined with a score in the set of scores further comprises:
for each set of metrics having a common number of basis orientations,
for each rotational state of the character-containing subregion that is used, in combination with the basis orientations associated with the set of metrics,
for each orientation-character/orientation pair for which a metrics-values set is stored in the set of orientation-character metrics-values sets corresponding to the set of metrics,
comparing the metric-values set for the rotational state of the character-containing subregion to the metrics-values set for the orientation-character/orientation pair to generate a score;
combining the basis orientation of the orientation-character/orientation pair and rotational state to generate an orientation;
identifying a score in the set of scores corresponding to the orientation character and generated orientation; and
modifying the identified score to have a new value obtained by combing the current value of the identified score with the generated score.

8. The image processing system of claim 7 wherein comparing the metric-values set for the rotational state of the character-containing subregion to the metrics-values set for the orientation-character/orientation pair to generate a score further comprises:
initializing a comparison value; and
for each set of metric values in the metrics-values set for the rotational state of the character-containing subregion, comparing the set of metric values to a corresponding set of metric values in the metrics-values set for the orientation-character/orientation pair to generate a value that is combined with the current value of the comparison value to generate a new value for the comparison value.

9. The image processing system of claim 6 wherein a score in the set of scores indicates that the orientation-character/orientation pair corresponding to the score matches the character-containing subregion when:
the score has a value at an extreme of the range of score values in the set of scores; and
the difference between the value of the score and the closest value of any other score is greater than a threshold difference.

10. The image processing system of claim 6 wherein each of the metric value in the sets of metric values within each metrics-values set is generated by a function that is computed from a bit-map representation of either an orientation character or the character-containing subregion.

11. The image processing system of claim 1 wherein determining an orientation for the text-containing region from the orientations of the number of character-containing subregions that each matches an orientation-character/orientation pair further comprises:
selecting, as the determined orientation, an orientation associated with a greatest number of the character-containing subregions.

12. A method carried out within an image processing system that determines an orientation for a text-containing region of an image, the image processing system having one or more processors, one or more electronic memories, one or more mass-storage devices, one or more sets of orientation-character metrics-values sets stored in one or more of the one or more electronic data storage devices, the method comprising:
receiving an image with a text-containing region;
storing a representation of the text-containing region in one or more of the one or more electronic memories;
identifying a number of character-containing subregions within the text-containing region that each matches an orientation-character/orientation pair by comparing one or more metrics-values sets computed for each of two or more rotational states of the character-containing subregion to metrics-values sets stored for each orientation character in the one or more sets of orientation-character metrics-values sets; and
determining an orientation for the text-containing region from the orientations of the number of character-containing subregions that each matches an orientation-character/orientation pair.

13. The method of claim 12
wherein each set of orientation-character metrics-values sets corresponds to a set of metrics having a common number of basis orientations;
wherein each set of orientation-character metric-values sets includes a metrics-values set for each orientation character in each basis orientation for the set of orientation-character metrics-values sets; and
wherein each metrics-values set includes a set of metric values for each metric.

14. The method of claim 13 wherein identifying a number of character-containing subregions within the text-containing region that each matches an orientation-character/orientation pair further comprises:
for each character-containing subregion within the text-containing region,
initializing a set of scores containing a score for each orientation-character/orientation pair,
for each rotational state of the character-containing subregion that is used, in combination with a basis orientation of an orientation character, to determine the orientation of the orientation character with respect to the text-containing region,
for each set of metrics having a common number of basis orientations,
computing a metrics-values set,
comparing each metrics-values set computed for the character-containing subregion to each metrics-values set in the one or more sets of orientation-character metrics-values sets to generate a score that is combined with a score in the set of scores;
when a score in the set of scores indicates that the orientation-character/orientation pair corresponding to the score matches the character-containing subregion, returning the orientation of the orientation-character/orientation pair associated with the score as the orientation of the character-containing subregion.

15. The method of claim 14 wherein comparing each metrics-values set computed for the character-containing subregion to each metrics-values set in the one or more sets of orientation-character metrics-values sets to generate a score that is combined with a score in the set of scores further comprises:
for each set of metrics having a common number of basis orientations,
for each rotational state of the character-containing subregion that is used, in combination with the basis orientations associated with the set of metrics,
for each orientation-character/orientation pair for which a metrics-values set is stored in the set of orientation-character metrics-values sets corresponding to the set of metrics,
comparing the metric-values set for the rotational state of the character-containing subregion to the metrics-values set for the orientation-character/orientation pair to generate a score;
combining the basis orientation of the orientation-character/orientation pair and rotational state to generate an orientation;
identifying a score in the set of scores corresponding to the orientation character and generated orientation; and
modifying the identified score to have a new value obtained by combing the current value of the identified score with the generated score.

16. The method of claim 15 wherein comparing the metric-values set for the rotational state of the character-containing subregion to the metrics-values set for the orientation-character/orientation pair to generate a score further comprises:
initializing a comparison value; and
for each set of metric values in the metrics-values set for the rotational state of the character-containing subregion, comparing the set of metric values to a corresponding set of metric values in the metrics-values set for the orientation-character/orientation pair to generate a value that is combined with the current value of the comparison value to generate a new value for the comparison value.

17. The method of claim 14 wherein a score in the set of scores indicates that the orientation-character/orientation pair corresponding to the score matches the character-containing subregion when:
the score has a value at an extreme of the range of score values in the set of scores; and
the difference between the value of the score and the closest value of any other score is greater than a threshold difference.

18. The method of claim 14 wherein each of the metric value in the sets of metric values within each metrics-values set is generated by a function that is computed from a bit-map representation of either an orientation character or the character-containing subregion.

19. A physical data-storage device storing computer instructions that, when retrieved from the physical data-storage device and executed by one or more processors of an image processing system having the one or more processors, one or more electronic memories, one or more mass-storage devices, one or more sets of orientation-character metrics-values sets stored in one or more of the one or more electronic data storage devices, control the image processing system to
receive an image with a text-containing region;
store a representation of the text-containing region in one or more of the one or more electronic memories;
identify a number of character-containing subregions within the text-containing region that each matches an orientation-character/orientation pair by comparing one or more metrics-values sets computed for each of two or more rotational states of the character-containing subregion to metrics-values sets stored for each orientation character in the one or more sets of orientation-character metrics-values sets; and
determine an orientation for the text-containing region from the orientations of the number of character-containing subregions that each matches an orientation-character/orientation pair.

20. The physical data-storage device of claim 19
wherein each set of orientation-character metrics-values sets corresponds to a set of metrics having a common number of basis orientations;
wherein each set of orientation-character metric-values sets includes a metrics-values set for each orientation character in each basis orientation for the set of orientation-character metrics-values sets; and
wherein each metrics-values set includes a set of metric values for each metric.
